(19) United States
(12) Patent Application Publication
(10) Pub. No.: US 2003/0029380 A1
(43) Pub. Date: Feb. 13, 2003

(54) Medical ink-jet recording apparatus

(76) Inventors: Masayuki Nakazawa, Hachioji-shi (JP); Akira Yamano, Hachioji-shi (JP); Chika Honda, Hachioji-shi (JP)

Correspondence Address: Cameron Kerrigan, Squire, Sanders & Dempsey L.L.P., One Maritime Plaza, Suite 300, San Francisco, CA, 94111, US

(21) Appl. No.: 10/186,352

(22) Filed: Jun. 28, 2002

(30) Foreign Application Priority Data
Jul. 4, 2001 (JP) 2001-203578

(51) Int. Cl. B05C 11/00

(52) U.S. Cl. 118/688; 118/689; 118/300

(57) ABSTRACT

There is described a medical image recording apparatus, which records a medical image on a recording medium based on image data. The apparatus includes an ink-jetting head to emit ink particles onto the recording medium and a controlling section to control the ink-jetting head, so that a total amount of the ink particles per unit area, emitted by the ink-jetting head and adhered onto the recording medium, is maintained at substantially a constant value even if density of a solid-tone image area varies within density range D. With respect to at least one of combinations of values k1, k2 selected under conditions of 0≦k1<1, 0<k2<1.0, and k1<k2, the density range D fulfils the equation of Dmin+k1(Dmax−Dmin)≦D≦Dmin+k2(Dmax−Dmin), where, Dmax is a recordable maximum-density, and Dmin is a recordable minimum-density.

### BACKGROUND OF THE INVENTION

The present invention relates to a medical image recording apparatus that records on a recording medium based on image information, and more particularly, to a medical image recording apparatus that records, on an ink-jet recording basis, medical image information obtained by an inputting apparatus such as a medical image radiographing apparatus.

There has recently been developed a method to obtain medical radiation image information without using a radiographic film that is made of a silver halide based photographic material. For example, there has been popularized a radiation image reading apparatus (Computed Radiography, hereinafter referred to as CR representing an abbreviation) wherein an imaging plate composed mainly of stimulable phosphor is used, and radiation images are accumulated temporarily and then are taken out by excitation light as stimulation emitted light to be transferred photoelectrically for obtaining image signals.

In recent years, there is also proposed an apparatus (Flat Panel Detector, hereinafter referred to as FPD) that reads radiation image information by combining a two-dimensional semi-conductor detector such as a TFT switching element with a radiation phosphor or a radiation photoconductor.

Further, there have been popularized radiation image inputting apparatuses which are not for simple X-ray photography, such as an X-ray computer tomography apparatus (X-ray CT apparatus) and a magnetic resonance image forming apparatus (MRI apparatus) . In these medical image inputting apparatuses, image information is offered in a form of a digital signal in many cases.

When the medical images stated above are used for diagnoses, a method to observe in the form of a hard copy by recording image information on a transmission-type recording medium and/or a reflection-type recording medium is used more popularly. As a medical image recording apparatus for recording medical image information on a recording medium, there is used more popularly a method to record an image by conducting laser exposure on a transmission-type recording medium employing a silver halide recording material. This method makes it possible to describe a monochromatic and multicontrast image under the excellent gradient, and to obtain high diagnostic capability by recording on a transmission-type medium and by observing with transmitted light.

Incidentally, in recent years, a possibility to record a medical image by using a recording apparatus of an ink-jet type is expected.

The following are generally known as a method to record a multi-level image with an ink dot of an ink-jet printer or the like.

1) An analog modulation method to change a diameter of an ink dot sticking to a recording sheet by changing voltage to be impressed on a recording head or a pulse width.

2) A digital modulation method to conduct gradation recording by changing the number of dots to be put in a dot matrix, without changing an ink dot diameter.

3) A digital/analog modulation method to change both a diameter of an ink dot sticking to a recording sheet and the number of dots by combining the analog modulation method in the aforesaid item 1) and the digital modulation method in the aforesaid item 2).

However, in either one of the recording methods, there is a limit of the minimum dot diameter which can be recorded through ink-jet recording. Therefore, a density change on the highlight (low density) area, especially, a density change on a density area where a dot starts to be recorded on a recording sheet is great, and thereby, gradation characteristics on that density area has been worsened.

Even in the case of a smooth change in gradation on a document, there are caused some fluctuations on the data obtained actually through reading because of the dispersion of inputting conditions including an inputting sensor. Therefore, on the highlight area mentioned above, a dot is sometimes recorded and it is not recorded on another occasion, resulting in image quality that gives an impression of roughness.

For the purpose of improving gradation characteristics, especially, of improving gradation characteristics on the highlight section, there has been proposed a technique to use a plurality of ink each having different density for the same color. However, in the method to use two kinds of ink including dark ink and light ink, for example, dye density of light ink needs to be lowered for improving gradation characteristics on the highlight section, and a pseudo contour resulting from an image color difference between two ink each having different density is caused on a boarder section between dark ink and light ink, resulting in a problem of deterioration of image quality.

For this reason, there is considered an outputting method wherein three types of ink including dark, medium and light ink are used so that a low density area may be printed with low density ink, a medium density area may be printed with medium density ink and a high density area may be printed with high density ink. In this method, a pseudo contour resulting from an image color difference is still caused, although gradation characteristics are improved because many tonal steps of image can be set. Therefore, to prevent this problem, there is needed a technique to unify an image color on all density areas.

Although it is preferable to combine optionally three types of ink dots including dark, medium and light ink dots for setting many gradations each being capable of expressing, when many ink are piled on the same location, ink cannot be absorbed completely by a recording sheet, causing feathering, and the recording sheet becomes wavy.

In the case of ink-jet recording, plural heads are arranged to be away from each other, and therefore, a distance between the head and a recording sheet is not kept constant, resulting in problems that accurate gradation recording cannot be carried out, and when the worst comes to the worst, the head comes in contact with a recording sheet to damage it.

A proposal described in TOKKOHEI No. 5-46745 has been made to improve the problem of a pseudo contour as that stated above.

However, it has been found that even the technology of TOKKOHEI No. 5-467465 does not have sufficient effect to control the pseudo contour, and image gradation characteristics are changed with the lapse of time. Namely, it was found that this problem is especially remarkable when a medical image is observed by the use of a transparent recording medium of a void type.

As a result of intensive study by the inventor of the present invention on the aforesaid point, it was found that light scattering caused by a solvent sticking to the inside of a void raises image density, or transmission density in particular. Namely, in addition to the density intended originally which is generated by coloring material sticking to the recording medium, density resulting from a solvent sticking to the inside of the void is added. An amount of this raising of density is increased simply as an amount of a sticking solvent is increased, and it is not so dependent on ingredient of the solvent. Further, an amount of raising for density is decreased when water in the sticking solvent evaporates, resulting in an aging change of image density. Further, there remains raising of density caused by light scattering of organic solvent which remains without evaporating.

In the dot formation in FIG. 5 described in TOKKOHEI No. 5-46745, an amount of ink, namely an amount of a solvent occupying the most part of the ink is different, depending on the gradation level. Since the amount of raising of transmission density caused by the solvent sticking to the inside of a void varies depending on the gradation level, the image density including raising of density caused by the solvent does not increase simply for the gradation level, and an inversion phenomenon sometimes takes place, although an amount of sticking dye increases simply for the gradation level. (This phenomenon is called density inversion hereafter.) This phenomenon causes a pseudo contour on an image, resulting in a fear of a cause of a wrong diagnosis. When an amount of raising of density is decreased by evaporation of water in the sticking solvent, a degree of aging change is also varied by the gradation level because the density raising by the solvent is varied depending on the gradation level, thus, an image before drying and an image after drying look as if they have been subjected to different gradation processing. Further, though there is no description about an amount of organic solvent in ink in TOKKOHEI No. 5-46745, when the percentage content of organic solvent is constant without being dependent on dye density of ink, density raising caused by organic solvent varies depending on the gradation level, and the pseudo contour is not eliminated completely even after the sufficient drying of moisture, because an amount of organic solvent is mostly proportional to an amount of sticking ink.

Incidentally, explanation of this portion will be made in detail together with that of the example as Comparative Example 1.

(2) Second Subject

In accordance with the contents of the description in TOKKAIHEI No. 9-277510, the content of an organic solvent is established to be mostly proportional to density of coloring material when using a plurality of ink each being different in terms of density.

If the present invention is applied to FIG. 5 described in TOKKOHEI No. 5-46745, a pseudo contour caused by density inversion does not take place after evaporation of moisture, because density raising caused by organic solvent included to be mostly proportional to dye density increases simply for the gradation level. However, a pseudo contour immediately after printing and an aging change of gradation characteristic take place, because density raising immediately after printing varies depending on an amount of sticking solvent (an amount of ink).

Incidentally, explanation of this portion will be made in detail together with that of the example as Comparative Example 2.

### SUMMARY OF THE INVENTION

To overcome the abovementioned drawbacks in conventional image-recording apparatus, it is an object of the present invention to provide an image-recording apparatus, such as an ink-jet printer especially suitable for medical use, which makes it possible to prevent occurrence of pseudo contour and an aging change of image gradation characteristics, and to produce a medical image hard copy that is excellent in both gradation and image quality.

Accordingly, to overcome the cited shortcomings, the abovementioned object of the present invention can be attained by image-recording apparatus described as follow.

(1) An apparatus for recording an image on a recording medium, comprising: an ink-jetting head to emit ink particles onto the recording medium; and a controlling section to control the ink-jetting head, so that a total amount of the ink particles per unit area, emitted by the ink-jetting head and adhered onto the recording medium, is maintained at substantially a constant value even if density of a solid-tone image area, to be recorded on the recording medium, varies within density range D; wherein, with respect to at least one of combinations of values k1, k2 selected under conditions of

0≦k1<1, 0<k2≦1.0, and k1<k2,

the density range D fulfils the following equation,

Dmin+k1(Dmax−Dmin)≦D≦Dmin+k2(Dmax−Dmin)

where,

Dmax: a recordable maximum-density,

Dmin: a recordable minimum-density.

(2) The apparatus of item 1, wherein the ink particles includes at least one of more than three kinds of inks having densities different each other in a same color tone.

(3) The apparatus of item 2, wherein the image is a medical image and the apparatus is an ink-jetting recording apparatus for medical use.

(4) The apparatus of item 1, wherein the ink particles includes an organic solvent; and wherein the controlling section controls the ink-jetting head, so that a total amount of the organic solvent per unit area is also maintained at substantially a constant value even if density of the solid-tone image area, to be recorded on the recording medium, varies within the density range D.

(5) The apparatus of item 3, wherein gradation of the image is created on the recording medium by forming dots in a dot-matrix including a plurality of cells, based on image data inputted into the apparatus, and the ink-jetting head emits the ink particles onto the recording medium so as to form the dots; and wherein the controlling section controls the ink-jetting head, so that an ink amount per each of the dots is kept at substantially a constant value and a total number of the dots in the dot-matrix, formed by the ink-jetting head onto the recording medium, is maintained at substantially a constant value even if density of the solid-tone image area, to be recorded on the recording medium, varies within the density range D.

(6) The apparatus of item 5, wherein a weight ratio of an organic solvent included in the ink particles is constant, irrespective of a density of a color material employed.

(7) The apparatus of item 3, wherein the ink particles have either a uniform density or two kinds of densities adjacent each other in order of color-material densities.

(8) The apparatus of item 3, wherein the values k1, k2 are defined as

k1=0.15, k2=0.4.

(9) The apparatus of item 3, wherein the values k1, k2 are defined as

k1=0.1, k2=0.6.

(10) The apparatus of item 3, wherein the values k1, k2 are defined as

k1=0, k2=1.0.

(11) The apparatus of item 2, wherein a transparent ink is included in the more than three kinds of inks.

(12) The apparatus of item 3, wherein the recording medium is transparent.

(13) The apparatus of item 3, wherein the total amount of the ink particles per unit area is controlled at substantially the constant value within a controlling error range of 10%.

(14) The apparatus of item 3, wherein, with respect to density range A other than the density range D, the controlling section controls the ink-jetting head, so that the total amount of the ink particles per unit area increases monotonically with increasing density in the density range A.

(15) An apparatus for recording an image on a recording medium, comprising: an ink-jetting head to emit ink particles onto the recording medium; and a controlling section to control the ink-jetting head, so that a total amount of organic solvent per unit area, included in the ink particles emitted by the ink-jetting head and adhered onto the recording medium, is maintained at substantially a constant value even if density of a solid-tone image area, to be recorded on the recording medium, varies within density range D; wherein, with respect to at least one of combinations of values k1, k2 selected under conditions of

0≦k1<1, 0<k21.0, and k1<k2,

the density range D fulfils the following equation,

Dmin+k1(Dmax−Dmin)≦D≦Dmin+k2(Dmax−Dmin)

where,

Dmax: a recordable maximum-density,

Dmin: a recordable minimum-density.

(16) The apparatus of item 15, wherein the ink particles includes at least one of more than three kinds of inks having densities different each other in a same color tone.

(17) The apparatus of item 16, wherein the image is a medical image and the apparatus is an ink-jetting recording apparatus for medical use.

(18) The apparatus of item 17, wherein gradation of the image is created on the recording medium by forming dots in a dot-matrix including a plurality of cells, based on image data inputted into the apparatus, and the ink-jetting head emits the ink particles onto the recording medium so as to form the dots; and wherein the controlling section controls the ink-jetting head, so that an ink amount per each of the dots is kept at substantially a constant value and a total number of the dots in the dot-matrix, formed by the ink-jetting head onto the recording medium, is maintained at substantially a constant value even if density of the solid-tone image area, to be recorded on the recording medium, varies within the density range D.

(19) The apparatus of item 17, wherein the ink particles have either a uniform density or two kinds of densities adjacent each other in order of color-material densities.

(20) The apparatus of item 17, wherein the values k1, k2 are defined as

k1=0.15, k2=0.4

(21) The apparatus of item 17, wherein the values k1, k2 are defined as

k1=0.1, k2=0.6

(22) The apparatus of item 17, wherein the values k1, k2 are defined as

k1=0, k2=1.0

(23) The apparatus of item 16, wherein a transparent ink is included in the more than three kinds of inks.

(24) The apparatus of item 17, wherein the recording medium is transparent.

(25) The apparatus of item 17, wherein the total amount of the organic solvent per unit area is controlled at substantially the constant value within a controlling error range of 10%.

(26) The apparatus of item 17, wherein, with respect to density range A other than the density range D, the controlling section controls the ink-jetting head, so that the total amount of the organic solvent per unit area increases monotonically with increasing density in the density range A.

Further, to overcome the abovementioned problems, other image-recording apparatus, embodied in the present invention, will be described as follow:

### Structure (1)

A medical ink-jet recording apparatus that records a medical image by using three or more types of ink each being of the same image color and having different density, wherein an amount of ink sticking to a recording medium is controlled to be almost constant even when density to be recorded is different, when solid recording in a density range from Dmin+k1×(Dmax−Dmin) to Dmin+k2×(Dmax−Dmin) is conducted for at least one of combinations of values k1, k2, under the assumption of Dmax representing the recordable maximum density, Dmin representing the recordable minimum density, 0≦k1 ≦1, 0<k2<1.0 and k1<k2.

In this invention, when recording a medical image by using three or more types of ink each being of the same image color and having different density, an amount of ink sticking to a recording medium is controlled to be almost constant even when density to be recorded is different, when solid recording in either one of the aforesaid density ranges is conducted.

If an amount of sticking ink is constant without depending on image density (gradation level), there comes the situation wherein raising of density caused by a solvent in an ink receiving layer immediately after image recording does not depend on image density (gradation level).

Namely, in the gradation characteristics right after image recording, inversion of image density for the gradation level does not take place, resulting in the preferable situation. As a result, it becomes possible to prevent occurrence of a pseudo contour immediately after image recording and to obtain a medical image hard copy having excellent gradation and image quality.

### Structure (2)

A medical ink-jet recording apparatus that records a medical image by using three or more types of ink each being of the same image color and having different density, wherein an amount of organic solvent sticking to a recording medium is controlled to be almost constant even when density to be recorded is different, when solid recording in a density range from Dmin+k1×(Dmax−Dmin) to Dmin+k2×(Dmax−Dmin) is conducted for at least one of combinations of values k1, k2, under the assumption of Dmax representing the recordable maximum density, Dmin representing the recordable minimum density, 0≦k1<1, 0<k2≦1.0 and k1<k2.

In this invention, when recording a medical image by using three or more types of ink each being of the same image color and having different density, an amount of organic solvent sticking to a recording medium is controlled to be almost constant even when density to be recorded is different, when solid recording in either one of the aforesaid density ranges is conducted.

If an amount of sticking organic solvent is constant without depending on image density (gradation level), there comes the situation wherein an amount of scattering of light caused by an organic solvent remaining in a recording medium does not depend on image density (gradation level).

Namely, in the state where moisture in ink is evaporated and dried sufficiently, inversion of density for the gradation level does not take place, resulting in the preferable situation. As a result, it becomes possible to prevent occurrence of a pseudo contour after drying and to obtain a medical image hard copy having excellent gradation and image quality.

### Structure (3)

A medical ink-jet recording apparatus that records a medical image by using three or more types of ink each being of the same image color and having different density, wherein an amount of ink and an amount of organic solvent both sticking to a recording medium are controlled to be almost constant even when density to be recorded is different, when solid recording in a density range from Dmin+k1×(Dmax−Dmin) to Dmin+k2×(Dmax−Dmin) is conducted for at least one of combinations of values k1, k2, under the assumption of Dmax representing the recordable maximum density, Dmin representing the recordable minimum density, 0≦k1<1, 0<k2≦1.0 and k1<k2.

In this invention, when recording a medical image by using three or more types of ink each being of the same image color and having different density, an amount of ink and an amount of organic solvent both sticking to a recording medium are controlled to be almost constant even when density to be recorded is different, when solid recording in either one of the aforesaid density ranges is conducted.

If an amount of sticking ink and an amount of sticking organic solvent are constant without depending on image density (gradation level), there becomes the situation wherein scattering of light caused by a solvent in a recording medium right after recording, density change caused by evaporation of water in a solvent and scattering of light caused by organic solvent remaining in a recording medium after drying do not depend on image density (gradation level).

Namely, only difference between the moment right after image recording and the moment after the lapse of a certain period of time is only parallel movement of gradation characteristics, which brings the state of no feeling of physical disorder even if the gradation characteristics are changed, which is preferable. As a result, it becomes possible to prevent occurrence of a pseudo contour after drying and to obtain a medical image hard copy having excellent gradation and image quality.

### Structure (4)

A medical ink-jet recording apparatus that forms dots in a dot matrix composed of a plurality of cells for gradation recording in accordance with inputted medical image information by using three or more types of ink each being of the same image color and having different density, wherein an amount of droplet per dot is controlled to be almost constant, and the number of dots in a dot matrix is controlled to be almost constant even when density to be recorded is different, when solid recording in a density range from Dmin+k1×(Dmax−Dmin) to Dmin+k2×(Dmax−Dmin) is conducted for at least one of combinations of values k1, k2, under the assumption of Dmax representing the recordable maximum density, Dmin representing the recordable minimum density, 0≦k1<1, 0<k2≦1.0 and k1<k2.

In this invention, when recording a medical image by using three or more types of ink each being of the same image color and having different density, an amount of droplet per dot is controlled to be almost constant, and the number of dots on a recording medium is controlled to be almost constant even when density to be recorded is different, when solid recording in either one of the aforesaid density ranges is conducted.

If an amount of droplet per dot and the number of dots in a matrix are constant without depending on image density (gradation level), there comes the situation wherein raising of density caused by a solvent in an ink receiving layer at the moment right after image recording does not depend on image density (gradation level).

Namely, in the gradation characteristics at the moment right after image recording, inversion of image density for the gradation level does not take place, resulting in the preferable situation. As a result, it becomes possible to prevent occurrence of a pseudo contour at the moment right after image recording and to obtain a medical image hard copy having excellent gradation and image quality.

### Structure (5)

The medical ink-jet recording apparatus according to Structure (4), wherein there is used ink in which weight ratio of organic solvent contained in the ink is constant without depending on density of coloring material.

If there is used ink in which weight ratio of organic solvent contained in the ink is constant without depending on density of coloring material, in addition to the control for the constant number of dots as stated above, there comes the situation wherein an amount of scattering of light caused by organic solvent remaining in a recording medium does not depend on image density (gradation level), thus, inversion of density for the gradation level does not take place under the state where moisture in ink has been evaporated and dried sufficiently, and only difference between the moment right after image recording and the moment after the lapse of a certain period of time is just a parallel movement of gradation characteristics, which is preferable. As a result, it becomes possible to prevent occurrence of a pseudo contour at the moment right after image recording and to obtain a medical image hard copy having excellent gradation and image quality.

### Structure (6)

The medical ink-jet recording apparatus according to either Structure (4) or Structure (5), wherein density of dots formed in the dot matrix is in one kind or in two kinds which adjoin each other in the order of densities of coloring materials.

In this invention, when recording a medical image by using three or more types of ink each being of the same image color and having different density, the number of dots on a recording medium is controlled to be almost constant in the case of solid recording, and density of the dot formed in the dot matrix is controlled to be in one kind or two kinds adjoining in the order of densities of coloring materials.

In this case, “two kinds adjoining in the order of coloring materials” means that the order of ink arranged in the sequence of density of coloring materials is represented by adjoining two kinds. For example, when using four kinds of ink having respectively 1-4 ink densities, “two kinds adjoining in the order of coloring materials” is represented by the combination of “1 and 2”, “2 and 3” or “3 and 4” under the assumption that the ink is ranked in the order toward lighter density to be 1, 2, 3 and 4.

When the number of dots is constant without depending on image densty (gradation level) and when the ink comes in one kind or in two kinds in terms of density as stated above, there comes the situation where raising of density caused by a solvent in an ink receiving layer at the moment right after image recording does not depend on image density (gradation level), and local density unevenness in the dot matrix can be controlled to be minimum.

As a result, it becomes possible to prevent occurrence of a pseudo contour and to obtain a medical image hard copy having excellent gradation, image quality and graininess.

### Structure (7)

The medical ink-jet recording apparatus according to either one of Structures (1)-(6), wherein k1=0.15 and k2=0.4 hold.

In this invention, when recording a medical image by using three or more types of ink each being of the same image color and having different density, the control to make an amount of ink sticking to a recording medium, an amount of sticking organic solvent and the number of dots to be almost constant in the case of solid recording is conducted under the solid recording in the density range from Dmin+0.15×(Dmax−Dmin) to Dmin+0.4×(Dmax−Dmin), namely, in the density range from 0.85Dmin+0.15Dmax to 0.6Dmin+0.4Dmax.

When the control to make an amount of sticking ink, an amount of sticking organic solvent and the number of dots to be constant without depending on image density (gradation level) is conducted in the prescribed density range as stated above, there comes the situation where density fluctuation caused by evaporation of water in a solvent and scattering of light caused by organic solvent in a recording medium do not depend on image density (gradation level), in the density range in which emphasis is put on gradation property in image diagnosis. Namely, there comes the state of no feeling of physical disorder even if the gradation characteristics are changed, which is preferable, because only difference between the moment right after image recording and the moment after the lapse of a certain period of time is only parallel movement of gradation characteristics.

As a result, it becomes possible to prevent occurrence of a pseudo contour and an aging change of image gradation property and to obtain a medical image hard copy having excellent gradation and image quality.

### Structure (8)

The medical ink-jet recording apparatus according to either one of Structures (1)-(6), wherein k1=0.1 and k2=0.6 hold.

In this invention, when recording a medical image by using three or more types of ink each being of the same image color and having different density, the control to make an amount of ink sticking to a recording medium, an amount of sticking organic solvent and the number of dots to be almost constant in the case of solid recording is conducted under the solid recording in the density range from Dmin+0.1×(Dmax−Dmin) to Dmin+0.6×(Dmax−Dmin), namely, in the density range from 0.9Dmin+0.1Dmax to 0.4Dmin+0.6Dmax.

When the control to make an amount of sticking ink, an amount of sticking organic solvent and the number of dots to be constant without depending on image density (gradation level) is conducted in the prescribed density range as stated above, there comes the situation where density fluctuation caused by evaporation of water in a solvent and scattering of light caused by organic solvent in a recording medium do not depend on image density (gradation level), in the density range in which emphasis is put on gradation property in image diagnosis. Namely, there comes the state of no feeling of physical disorder even if the gradation characteristics are changed, which is preferable, because only difference between the moment right after image recording and the moment after the lapse of a certain period of time is only parallel movement of gradation characteristics.

As a result, it becomes possible to prevent occurrence of a pseudo contour and an aging change of image gradation property and to obtain a medical image hard copy having excellent gradation and image quality, in a density range where the greatest emphasis is put on gradation property in image diagnosis.

### Structure (9)

The medical ink-jet recording apparatus according to either one of Structures (1)-(6), wherein k1=0 and k2 1.0 hold.

In this invention, when recording a medical image by using three or more types of ink each being of the same image color and having different density, the control to make an amount of ink sticking to a recording medium, an amount of sticking organic solvent and the number of dots to be almost constant in the case of solid recording is conducted under the solid recording in the density range from Dmin+0×(Dmax−Dmin) to Dmin+1.0×(Dmax−Dmin), namely, in the density range from Dmin to Dmax.

When the control to make an amount of sticking ink, an amount of sticking organic solvent and the number of dots to be constant without depending on image density (gradation level) is conducted in the prescribed density range as stated above, there comes the situation where density fluctuation caused by evaporation of water in a solvent and scattering of light caused by organic solvent in a recording medium do not depend on image density (gradation level), in the all density ranges including the density range in which the greatest emphasis is put on gradation property in image diagnosis. Namely, there comes the state of no feeling of physical disorder even if the gradation characteristics are changed, which is preferable, because only difference between the moment right after image recording and the moment after the lapse of a certain period of time is only parallel movement of gradation characteristics.

As a result, it becomes possible to prevent occurrence of a pseudo contour and an aging change of image gradation property and to obtain a medical image hard copy having excellent gradation and image quality, in a density range where the greatest emphasis is put on gradation property in image diagnosis.

### Structure (10)

The medical ink-jet recording apparatus according to either one of Structures (1)-(9), wherein transparent ink is used together with the ink mentioned above.

In this invention, it is possible to expand easily the range of image density (gradation level) which can make an amount of sticking ink and an amount of sticking organic solvent to be constant, by using transparent ink when conducting the control to make an amount of sticking ink and an amount of sticking organic solvent to be constant without depending on image density (gradation level), which is preferable.

### Structure (11)

The medical ink-jet recording apparatus according to either one of Structures (1)-(10), wherein an error of the control to make constant is within 10%.

In this invention, it becomes possible to prevent occurrence of a pseudo contour and an aging change of image characteristics and to obtain stably a medical image hard copy having excellent gradation and image quality, with a simple structure and control, because an error is controlled to be within a range of 10% for the control to make an amount of sticking ink and an amount of sticking organic solvent to be constant.

### Structure (12)

The medical ink-jet recording apparatus according to either one of Structures (1)-(10), wherein a transparent recording medium is used as the recording medium mentioned above.

In this invention, it becomes possible to prevent occurrence of a pseudo contour and an aging change of image characteristics and to obtain a medical image hard copy having excellent gradation and image quality, even in the case of observing images by the use of transmission light, because the control to make an amount of sticking ink and an amount of sticking organic solvent to be constant is conducted in the course of image recording on the transparent recording medium.

### Structure (13)

The medical ink-jet recording apparatus according to either one of Structures (1)-(12), wherein, in the density range in which the control to make constant is not conducted, there is conducted a control to make an amount of sticking ink, an amount of sticking organic solvent, or the number of dots to be increased simply as image density increases.

In this invention, it becomes possible to prevent occurrence of a pseudo contour caused by density inversion and an aging change of image characteristics and to obtain a medical image hard copy having excellent gradation and image quality, even in the area where the aforesaid control is not conducted, because the control to make an amount of sticking ink, an amount of sticking organic solvent or the number of dots to be increased simply as image density increases is conducted in the density area where the control to make the amount of sticking ink and the amount of sticking organic solvent to be constant is not conducted.

### BRIEF DESCRIPTION OF THE DRAWINGS

Other objects and advantages of the present invention will become apparent upon reading the following detailed description and upon reference to the drawings in which:

FIG. 1 is a block diagram showing an electric structure of an apparatus representing an example of the embodiment of the invention;

FIG. 2 is a diagram of characteristics showing the principle of an example of the embodiment of the invention;

FIG. 3(a), FIG. 3(b), FIG. 3(c), FIG. 3(d), FIG. 3(e) and FIG. 3(f) are diagrams of characteristics showing characteristics of Example 1 of the invention.

FIG. 4 is a diagram of patterns showing dot patterns in Example 1 of the invention.

FIG. 5(a), FIG. 5(b), FIG. 5(c), FIG. 5(d), FIG. 5(e) and FIG. 5(f) are diagrams of characteristics showing characteristics of Example 2 of the invention;

FIG. 6 is a diagram of patterns showing dot patterns in Example 2 of the invention;

FIG. 7(a), FIG. 7(b), FIG. 7(c), FIG. 7(d), FIG. 7(e) and FIG. 7(f) are diagrams of characteristics showing characteristics of Example 3 of the invention;

FIG. 8 is a diagram of patterns showing dot patterns in Example 3 of the invention;

FIG. 9(a), FIG. 9(b), FIG. 9(c), FIG. 9(d), FIG. 9(e) and FIG. 9(f) are diagrams of characteristics showing characteristics of Example 4 of the invention;

FIG. 10 is a diagram of patterns showing dot patterns in Example 4 of the invention;

FIG. 11(a), FIG. 11(b), FIG. 11(c), FIG. 11(d), FIG. 11(e) and FIG. 11(f) are diagrams of characteristics showing characteristics of Comparative Example 1;

FIG. 12 is a diagram of patterns showing dot patterns in Comparative Example 1;

FIG. 13(a), FIG. 13(b), FIG. 13(c), FIG. 13(d), FIG. 13(e) and FIG. 13(f) are diagrams of characteristics showing characteristics of Comparative Example 2; and

FIG. 14 is a diagram of patterns showing dot patterns in Comparative Example 2.

### DETAILED DESCRIPTION OF THE PREFERRED EMBODIMENT

An embodiment of the invention will be explained in detail as follows, referring to the drawings. Incidentally, the invention is not limited to the embodiment described below.

### Total Structure of a Medical Ink-jet Recording Apparatus

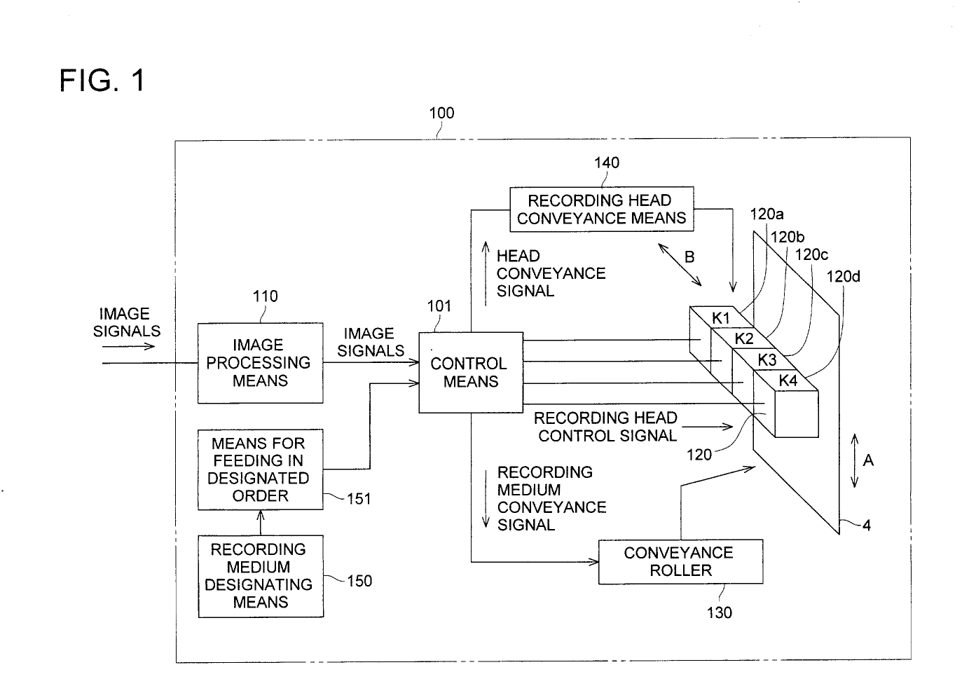

FIG. 1 is a block diagram for illustrating functional blocks relating to image recording conducted by a medical ink-jet recording apparatus. Medical ink-jet recording apparatus 100 in the present embodiment has therein recording head unit 120 as a recording means that conducts image recording through ink jet.

Control means 101 controls each section of the medical ink-jet recording apparatus 100 of the present embodiment. Further, the control means 101 also controls an amount of ink sticking to a recording medium as the control that constitutes a characteristic feature of the present embodiment.

The numeral 110 represents an image processing means which receives image signals from a medical radiographing apparatus and a storage apparatus both on the outside, and conducts necessary image processing. Incidentally, input of the image signals from the outside may also be one through each type of a network. The image signals processed by the image processing means 110 are sent to the control means 101.

On recording head unit 120, there are provided, in a line, recording heads 120a- 120d which are respectively for four types of black ink K1-K4 each being different from others in terms of density, and recording head control signals corresponding to the image signals are supplied from the control means 101 to the recording heads. These recording heads 120a- 120d may either be united solidly or be provided separately. By forming images by the use of four types of black ink each being different from others as in the foregoing, it is possible to obtain multicontrast images having higher image quality as images for a medical diagnosis or for reference. For making medical images on which multi-density levels are required, it is preferable to use at least three or four types of black ink each being different from others in terms of density. Incidentally, to solve the problem of streak type unevenness which is peculiar to an ink-jet recording apparatus, it is necessary to jet ink from a recording head to a recording surface uniformly, and as a result, an ink receiving layer needs to be thicker as an ink absorbing amount increases. If the ink receiving layer is made to be thicker, a crack tends to be caused on the surface of a recording surface, and a recording medium needs to be handled more carefully.

An ink jet mechanism of the ink jet head may either be one employing a piezoelectric effect or be one of a bubble jet method using a force of bubble forming generated when ink is heated instantly. The number of nozzle holes such as about 64-512 is appropriate as a medical ink-jet. A jetting speed of an ink droplet ranging from 2 m/s to 20 m/s is preferable, and an ink amount per one jetted droplet in 1-50 picoliter is preferable.

The numeral 130 is a conveyance roller that conveys recording medium 4 in the main scanning direction. The numeral 140 is a recording head conveyance means that conveys the recording head in the sub-scanning direction. The conveyance roller 130 conveys recording medium 4 in the direction of the arrow based on recording medium conveyance signals. Further, there is arranged recording head conveyance means 140 that moves recording head unit 120 to be movable in the direction B that is perpendicular to the conveyance direction for the recording medium 4.

The recording head conveyance means 140 moves the recording head unit 120 in the direction of the arrow B based on head conveyance signals, and each of recording heads 120a-120d forms an image on the recording medium 4 based on recording head control signals. To the control means 101, there are sent image signals from the image processing means 110 into which the image signals are inputted from the outer radiographing apparatus and storage apparatus. Incidentally, input for image processing may also be one through the network.

The numeral 150 is a recording medium specifying means that specifies the order of recording for recording medium 4. The unmeral 151 is a specified order feeding means that feeds recording medium 4 in accordance with the recording order specified by the use of the recording medium specifying means 150. This specified order feeding means 151 sends specified order feeding signals to the control means 101. By specifying the recording order for recording medium 4 and by feeding recording medium 4 in accordance with specified recording order, it is possible to prevent that recording media 4 are fed simultaneously.

### Explanation of Recording Medium

The recording medium of the present embodiment is characterized in that a monochromatic image is substantially drawn in liquefied ink. It is preferable that the recording medium is one that is in a shape of a sheet having practically an area of not less than 15×10 cm, and has rounded cut-outs on four corners, and is made of colorless or colored resin having a thickness of 75-250 μm, and has at least one void type ink absorbing layer on at least one surface.

When the recording medium is thinner than 75 μm, the sheet hangs down to become difficult to be handled, and when it is thicker than 250 μm, plural recording media weigh considerably when they are superposed to be carried, which is a disadvantage.

Since a conventional X-ray film used so far is colorless and transparent or is colored to be blue, it is preferable to use a support made of resin that is colorless or is colored to be blue, for the recording medium in the present embodiment.

Further, it is a preferable embodiment that the recording medium of the present embodiment has, on at least one side thereof, at least one void type ink absorbing layer, and the recording medium has, on its side having no ink absorbing layer, a layer that is subjected to matting treatment which is for mechanical transportability for the printer and for preventing that films stick each other when they are superposed.

The recording medium of the present embodiment can be obtained by making a void rate in the ink absorbing layer to be as great as possible, and by giving mat finishing to the surface so that irregularities may be generated on the surface.

Further, it is possible to add white metal oxide such as titanium oxide or lead oxide to an ink absorbing layer or to a layer under the ink absorbing layer.

It is also possible to provide a layer on the side opposite to the side having thereon the ink absorbing layer on the support to disperse metal oxide such as titanium oxide or lead oxide, and to provide ink absorbing layers on both sides the support.

As a material for the support of the recording medium in the present embodiment, it is possible to use polyesters such as polyethylene terephthalate, cellulose esters such as nitrocellulose and cellulose acetate, polysulfone, polyimide and polycarbonate. It is further preferable that the sheet-shaped recording medium is colored to be blue. This coloring in blue is for preventing that eyes are dazzled by excessive transmitted light coming from non-image area as stated above, and it also gives an effect to make the black image to look more preferable. Since an ink absorbing layer is provided on at least one surface of the sheet-shaped support accordingly, a support for the recording medium needs to be subjected to corona discharge processing, flame treatment and UV irradiation processing so that adhesiveness of an ink absorbing layer may be improved.

It is preferable that the ink absorbing layer is a layer with a three-dimensional network structure having porosity of 40-90%. It is preferable that this three-dimensional network structure is formed with silica fine particles with a mean particle diameter of not more than 20 nm, or it is formed with organic matter fine particles and water-soluble resins, and mass ratio of silica fine particles to water-soluble resins or the mass ratio of organic matter fine particles to water-soluble resins is within a range from 1.2:1 to 1.2:12.1.

In this case, a mean diameter of bores forming voids of the three-dimensional network structure is 5-40 nm, and the bores forming voids have bore capacity of 0.3-1 ml/g. It is preferable that silica particles represent inorganic silicic acid, and it has, on its surface, 2-3 shirarooru groups per 1 nm², and the three-dimensional network structure is constituted of a chain formed by connection of second order particle having a particle size of 10-100 nm where fine particles are condensed.

As a fine particle, it is possible to use, for example, colloidal silica, calcium silicate, zeolite, kaolinite, halosite, white mica, talc, calcium carbonate, calcium sulfate and aluminum oxide.

As water-soluble resin, polyvinyl alcohol is preferable, and as an example of another water-soluble resin, there are given gelatin and those disclosed in TOKKAIHEI 7-276789.

It is preferable that an ink absorbing layer has a specific surface area of 50-500 m²/g. Further, it is preferable to disperse matte particles with mean particle size of 5-100 μμm on the surface so that a sheet may not stick to another sheet when sheets are superposed.

It is also possible to add a surface active agent as an antistatic agent.

The surface having no ink absorbing layer may be coated with gelatin or water-soluble resin, for preventing curl. With regard to this layer, it is possible to conduct antistatic treatment and to conduct matte processing for preventing sticking on the layer, and it is possible to color the layer to be blue, and to add oxidized metal particle such as titanium oxide particle or zinc oxide particle to the layer.

In the case of interpretation of transmission radiographs, many films are handled in a short time in many cases. For making it possible to distinguish between the obverse and reverse of an image at a glance, in this case, it is preferable to be able to distinguish the obverse and reverse simply by providing, for example, a notch on the upper portion on the right side of the sheet.

### Explanation of Ink

In an example of the present embodiment, it is possible to form an image by jetting a plurality of ink each being different from others in terms of image color, by using an ink-jet head representing a means to make each of a plurality of ink to be jetted independently. It is further possible to form an image by jetting a plurality of ink each being monochromatic and different from others in terms of density, by using an ink-jet head representing a means to make each of a plurality of ink to be jetted independently.

An ink-jet head is used for each of ink of yellow (Y), magenta M), cyan (C) and black (K) . An ink-jet head may also be used for monochromatic ink with each ink density of plural steps, for example, of two steps, three steps and four steps, by using the aforesaid ink individually or in combination.

As a coloring material that is dissolved or dispersed in water of ink, it is possible to use any of a pigment, a water-soluble dye and a dispersed dye.

As a pigment, organic or inorganic pigment which has been known can be used. For example, azo pigments such as azolake, insoluble azo pigments, condensed azo pigments and chelated azo pigments; polycyclic pigments such as phthalocyanine pigments, perylene and perylene pigments, anthraquinone pigments, quinacridone pigments, dioxazine pigments, thioindigo pigments, isoindolinone pigments and quinophthalonine pigments; dye lake such as basic dye type lake and acid dye type lake; organic pigments such as nitro pigments, nitroso pigments and aniline black and daylight fluorescent pigments; and inorganic pigments such as carbon black are given.

As a dispersing method for a pigment, it is possible to use various types such as ball mill, sand mill, atreiter, roll mill, agitator, Henschel mixer, colloid mill, ultrasonic homogenizer, pearl mill, wet jet mill and paint shaker. Further, when dispersing a pigment, it is also possible to add a dispersing agent. As a dispersing agent, anion type and nonion type surface active agents or high molecular dispersing agents can be given.

With respect to ink used in the present embodiment, it is possible to prepare black ink by selecting an appropriate pigment, or combining known dyes or by using a dye of a single type.

As a water-soluble dye, an acid dye and a basic-dye-reactive dye, for example, may be given.

As a black dye, there are given CI (color index) direct blacks 9, 17, 19, 22, 32, 51, 56, 62, 69, 77, 80, 91, 94, 97, 108, 112, 113, 114, 117, 118, 121, 122, 125, 132, 146, 154, 166, 168, 173 and 199.

With respect to ink used in the present embodiment, it is possible to prepare black ink by selecting an appropriate pigment, or combining known dyes or by using a dye of a single type.

For example, as a pigment, there is used carbon black which is then mixed with an ethylene glycol and a surface active agent or a preservative, thus black ink which is liquid at ordinary temperature and is water-soluble is obtained.

When using a dye, it is possible to obtain water-soluble black ink which is liquid at ordinary temperature by preparing a solution wherein ethylene glycol, glycerin, a surface active agent and a preservative are added to direct black 19 (Direct Black 19), Direct Black 159, Surfer Black 1, Acid Black 2 or CI hood black 2. Direct black 19 (blue ink) is one used for adjustment of image color by mixing an appropriate amount.

It is preferable, as an image forming method, to cover a broad density area by using the aforesaid ink and combining ink each being different from others in terms of density and image color, while changing image color delicately in accordance with density change of an image.

When using ink each being different in terms of image color, acid blue 9 (Acid Black 9), acid red 52 (Acid Red 52) and 94, acid yellow 23 (Acid Yellow 23), direct yellow 86 (Direct Yellow 86) and 142 are used as a coloring material, and in preferable embodiment, there is used ink disclosed, for example, in TOKKAI No. 2000-129182.

As an example of a water-soluble organic solvent used for ink, there are given alcohols (e.g., methanol, ethanol, propanol, isopropanol, butanol, isobutanol, sec-butanol, tert-butanol, pentanol, hexanol, cyclohexanol, benzyl alcohol, etc.), polyols (e.g., ethylene glycol, diethylene glycol, triethylene glycol, polyethylene glycol, propylene glycol, dipropylene glycol, polypropylene glycol, butylenes glycol, hexane-diol, pentane-diol, glycerine, hexane-triol, thioglycol, etc.), polyol esters (ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monomethyl ether, propylene glycol monobutyl ether, ethylene glycol monometyl ether acetate, triethylene glycol monomethyl ether, triethylene glycol monoethyl ether, triethylene glycol monobutyl ether, ethylene glycol monophenyl ether, propylene glycol monophenyl ether, etc.), amines (e.g., ethanolamine, diethanolamine, triethanolamine, N-methylethanolamine, N-ethyldiethanolamine, morpholine, N-ethylmorpholine, ethelenediamine, diethylenediamine, triethylenetetramine, tetraethylenepentamine, polyethyleneimine, pentamethyldiethylenetriamine, tetramethylpropylenediamine, etc.), amides (e.g., formamide, N,N-dimethylformamide, N,N-dimethylacetoamide, etc.), heterocycles (e.g., 2-pyrrolidone, N-metyl-2-pyrrolidone, cyclohexylpyrrolidone, 2-oxazolidonel, 3-dimethyl-2-imidazolidinone, etc. 9, sulfoxides (e.g., dimethylsulfoxide, etc.), sulfons (e.g., sulfolane, etc.), urea,acetonitrile and acetone.

If necessary, a surface active agent may be added to ink. As a surface active agent used preferably for ink, there are given anionic surfactants such as dialkylsulfosuccinates, alkylnaphthalenesulfonates and carboxylates; nonionic surfactants such as polyoxyethylene alkyl ethers, polyoxyethylene alkylaryl ethers, acetylene glycols, and polyoxyethylene-polyoxypropylene block copolymers; and cationic surfactant such as alkylamines and quaternary ammonium salts.

It is also possible to add to ink an anticeptic agent, an antifungal agent, a pH modifier and a viscosity modifier, as occasion demands.

### Principle of the Present Embodiment

The present embodiment is represented by an ink-jet recording apparatus for recording medical images by using three or more types of ink each being of the same image color and having different density, wherein the control means controls an amount of ink sticking to a recording medium and an amount of organic solvent sticking, so that they may be constant mostly when solid recording is conducted within a density range from Dmin+k1×(Dmax−Dmin) Dmin+k2×(Dmax−Dmin) when Dmax represents the recordable maximum density and Dmin represents the recordable minimum density.

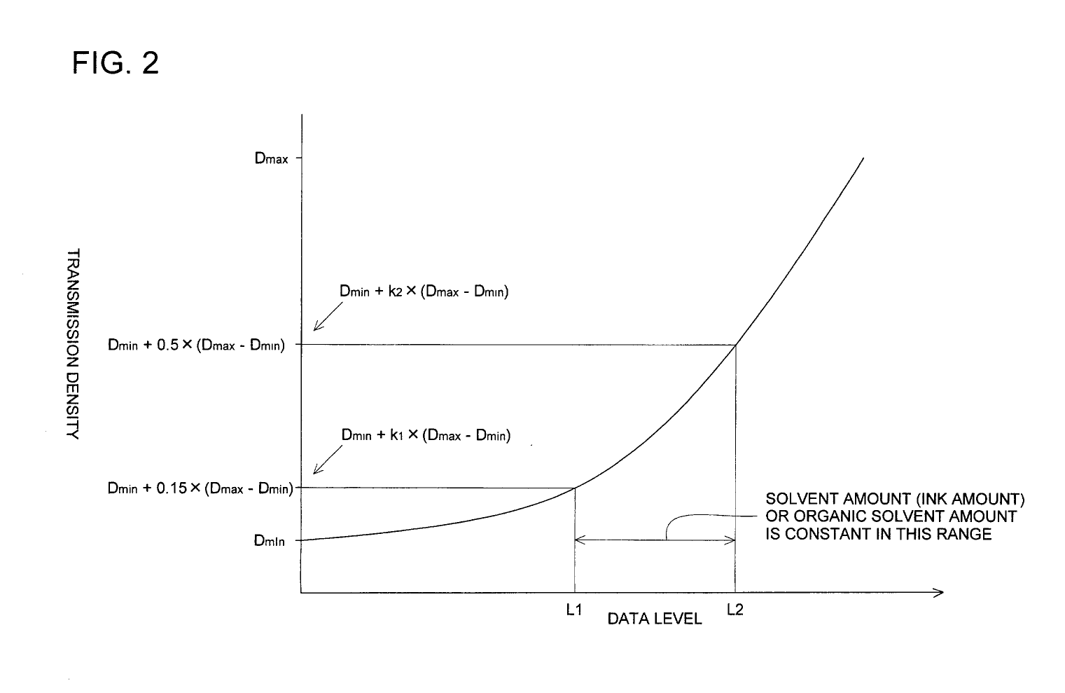

Namely, in the present embodiment, an amount of ink sticking to a recording medium and an amount of organic solvent sticking thereto are controlled so that they may be constant mostly when solid recording within a density range from Dmin+k1×(Dmax−Dmin) to Dmin+k2×(Dmax−Dmin) is conducted under the assumption that Dmax represents the recordable maximum density and Dmin represents the recordable minimum density and k1 is made to be equal to 0-0.15 and k2 is made to be equal to 0.4-1.0, in the case of solid recording of medical images by the use of three or more types of ink each being of the same image color and having different density. FIG. 2 shows relationship between inputted image signal data level and transmission density of an image to be recorded in an ink-jet recording apparatus of the invention. The axis of abscissa represents a data level of the inputted image signal value, while, the axis of ordinate represents transmission density of the image. The graph shown in FIG. 2 is an exemplified relationship in which k1=0.15 and k2=0.5. In this case, “controlling an amount of ink sticking to a recording medium to be almost constant even when density to be recorded varies in the case of solid recording within a density range from Dmin+k1×(Dmax−Dmin) to Dmin+k2×(Dmax−Dmin)” corresponds to controlling an amount of ink sticking to a recording medium to be almost constant in the image signal range between the data level L1 corresponding to transmission density of Dmin+0.15×(Dmax−Dmin) for the image and the data level L2 corresponding to transmission density of Dmin+0.5×(Dmax−Dmin) for the image.

For the control mentioned above, there are obtained the following (1)-(6) controlling methods and functions and effects corresponding to the controlling methods.

(1)

If an amount of sticking ink is constant without depending on image density (gradation level), there becomes the state wherein raising of density caused by a solvent in an ink receiving layer right after image recording does not depend on image density (gradation level). Namely, in the gradation characteristics right after image recording, reversing of image density for the gradation level does not take place, which is a preferable state. As a result, occurrence of a pseudo contour right after image recording is prevented, and it becomes possible to obtain a medical image hard copy having excellent gradation characteristics and high image quality.

(2)

If an amount of sticking organic solvent is constant without depending on image density (gradation level), there becomes the state wherein an amount of scattering light caused by organic solvent remaining in a recording medium does not depend on image density (gradation level). Namely, in the state where moisture in ink has been evaporated and dried sufficiently, reversing of density for the gradation level does not take place, which is a preferable state. As a result, occurrence of a pseudo contour after drying is prevented, and it becomes possible to obtain a medical image hard copy having excellent gradation characteristics and high image quality.

(3)

If an amount of sticking ink and an amount of sticking organic solvent are constant without depending on image density (gradation level), there becomes the state wherein scattering of light caused by a solvent in a recording medium right after recording, a density change caused by evaporation of moisture in the solvent, and scattering of light caused by organic solvent remaining in the recording medium after drying do not depend on image density (gradation level). Namely, Namely, only difference between the moment right after image recording and the moment after the lapse of a certain period of time is only parallel movement of gradation characteristics, which brings the state of no feeling of physical disorder even if the radation characteristics are changed, which is preferable. As a result, occurrence of a pseudo contour and an aging change of image gradation characteristics are prevented, and it becomes possible to obtain a medical image hard copy having excellent gradation characteristics and high image quality.

(4)

If an amount of droplet per one dot and the number of dots in a matrix are constant without depending on image density (gradation level), there becomes the state wherein raising of density caused by a solvent in an ink receiving layer right after image recording does not depend on image density (gradation level). Namely, in the gradation characteristics right after image recording, reversing of image density for the gradation level does not take place, which is a preferable state. As a result, occurrence of a pseudo contour right after image recording is prevented, and it becomes possible to obtain a medical image hard copy having excellent gradation characteristics and high image quality.

(5)

If there is used ink in which the weight ratio of organic solvent contained in the ink is constant without depending on density of coloring materials, by using ink in which the weight ratio of organic solvent contained in the ink is constant without depending on density of coloring materials, in addition to the control to make the number of dots to be constant, there becomes the state wherein an amount of light scattering caused by organic solvent remaining in a recording medium does not depend on image density (gradation level), and in the state where moisture in ink has been evaporated and dried sufficiently, reversing of density for the gradation level does not take place, and only difference between the moment right after image recording and the moment after the lapse of a certain period of time is only parallel movement of gradation characteristics, which is preferable. As a result, occurrence of a pseudo contour is prevented, and it becomes possible to obtain a medical image hard copy having excellent gradation characteristics and high image quality.

(6)

If the number of dots is constant without depending on image density (gradation level) and ink density is made to be of one type or two types which adjoin each other in the order of density of coloring materials, there becomes the state wherein raising of density caused by a solvent in an ink receiving layer right after image recording does not depend on image density (gradation level), and local density unevenness in a dot matrix is suppressed to the minimum. Namely, in the gradation characteristics right after image recording, reversing of image density for the gradation level does not take place, which is a preferable state. As a result, occurrence of a pseudo contour is prevented, and it becomes possible to obtain a medical image hard copy having excellent gradation characteristics and high image quality and to obtain a medical image hard copy excellent in graininess.

### EXAMPLE

There will be given the examples as follows to explain concretely the embodiments of the invention to which, however, the embodiments of the invention are not limited.

### Manufacture of a Recording Medium

### Preparation of a Support

Corona discharge treatment was conducted on each of both sides of a 175 μm-thick polyester base which has visible diffusion density of 0.14 and is colored blue. Then, for preventing curling and for avoiding static electricity, a backing layer including surfactants in a gelatin film was coated on the polyester base to prepare the support.

### Manufacture of a Recording Medium

Compositions shown below were added to 15 kg of water to be dispersed, and then, were adjusted to pH 4.0 to obtain a coating solution.

The coating solution thus obtained was coated on the surface on one side of the support that is colored to be blue, and thus, the medium sample was obtained.

### Ink Absorbing Layer Composition

Dry silica fine particle: 1 kg (Mean particle size 7 nm, shirarooru radical 2-3/nm²: aerojiru A300 (made by Japan aerojiru Co.))

Polyvinyl alcohol: 0.5 kg (Saponification degree 88%, degree of polymerization 3500: PVA 235 (made by kuraray Co., Ltd.))

### Preparation of Ink

Maximum density black ink 1 and maximum density black ink 2 both having the following composition and transparent ink 1 and transparent ink 2 were prepared.

### Maximum Density Black Ink 1 Composition

C.I Hood black 2: 35 g

Glycerin: 200 g

Emarugen 911 (made by Kao Co., Ltd.): 3 g

The above ingredients were added to deionized water to make 1000 g of ink.

### Maximum Density Black Ink 2 Composition

C.I Hood black 2: 35 g

Glycerin: 350 g

Emarugen 911 (made by Kao Co., Ltd.): 3 g

The above ingredients were added to deionized water to make 1000 g of ink.

### Transparent Ink 1 Composition

Glycerin: 200 g

Emarugen 911 (made by Kao Co., Ltd.): 3 g

The above ingredients were added to deionized water to make 1000 g of ink.

### Transparent Ink 2 Composition

Emarugen 911 (made by Kao Co., Ltd.): 3 g

The above ingredient was added to deionized water to make 1000 g of ink.

The maximum density black ink 1 and the transparent ink 1 both stated above were used as they are, and were mixed together to prepare ink set 1 (transparent ink 1-1, very light ink 1-2, light ink 1-3, medium ink 1-4 and dark ink 1-5) and ink set 2 (transparent ink 2-1, light ink 2-3, medium ink 2-4 and dark ink 2-5) wherein the percentage content of organic solvent (glycerin in this example) is constant without depending on density of a dye.

Further, the maximum density black ink 2 and the transparent ink 2 both stated above were used as they are, and were mixed together to prepare ink set 3 (transparent ink 3-1, light ink 3-3, medium ink 3-4 and dark ink 3-5) wherein the percentage content of organic solvent (glycerin in this example) is mostly proportional to density of a dye.

Table 1 shows density of a dye and a percentage of content of organic solvent in each of ink sets 1. 2 and 3.

TABLE 1
Ink sets and dye density as well as percentage of content of
organic solvent for each ink

| | | Trans- | Very | Light | Medium | Dark |
|---|---|---|---|---|---|---|
| | | parent | light ink | ink | ink | ink |
| Ink | Ink No. | 1-1 | 1-2 | 1-3 | 1-4 | 1-5 |
| set | Dye density | 0% | 0.31% | 0.70% | 1.57% | 3.50% |
| 1 | Content of | 20.0% | 20.0% | 20.0% | 20.0% | 20.0% |
| | organic | | | | | |
| | solvent | | | | | |
| Ink | Ink No. | 2-1 | Not | 2-3 | 2-4 | 2-5 |
| set | Dye density | 0% | prepared | 0.22% | 0.72% | 3.50% |
| 2 | Content of | 20.0% | | 20.0% | 20.0% | 20.0% |
| | organic | | | | | |
| | solvent | | | | | |
| Ink | Ink No. | 3-1 | Not | 3-3 | 3-4 | 3-5 |
| set | Dye density | 0% | prepared | 0.22% | 0.72% | 3.50% |
| 3 | Content of | 0.0% | | 2.20% | 7.20% | 35.00% |
| | organic | | | | | |
| | solvent | | | | | |

### Printer

An ink-jet printer of an on-demand type was used under the conditions wherein a bore of a nozzle is 24 μm, a nozzle head employs 256 nozzles, driving frequency is 12 kHz, an ink jetting speed is 6 m/sec, a volume of a droplet is 7 picoliters and the number of dots is 1440 dots/ 25.4 mm (recording density: the number of dots per 2.54 cm).

Further, dot patterns of ink and cell used in Example 1-Example 4 and in Comparative Example 1 and Comparative Example 2 are shown in Table 2.

Numbers in the drawing indicating ink numbers and dot patterns in the dot matrix used in Example 1-Example 4 and in Comparative Example 1 and Comparative Example 2 are shown in Table 2.

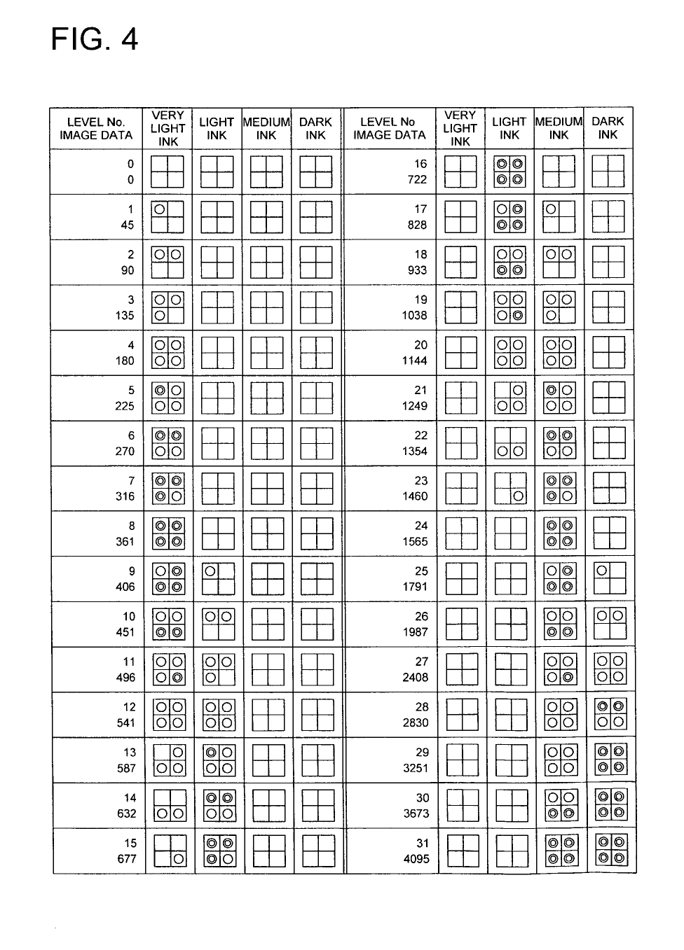

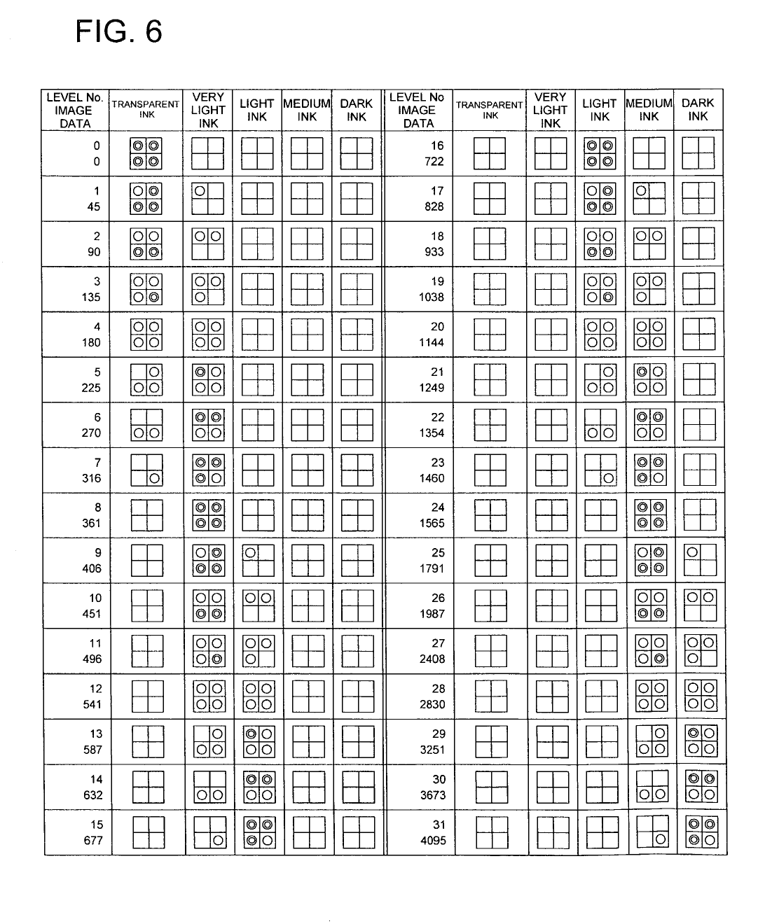

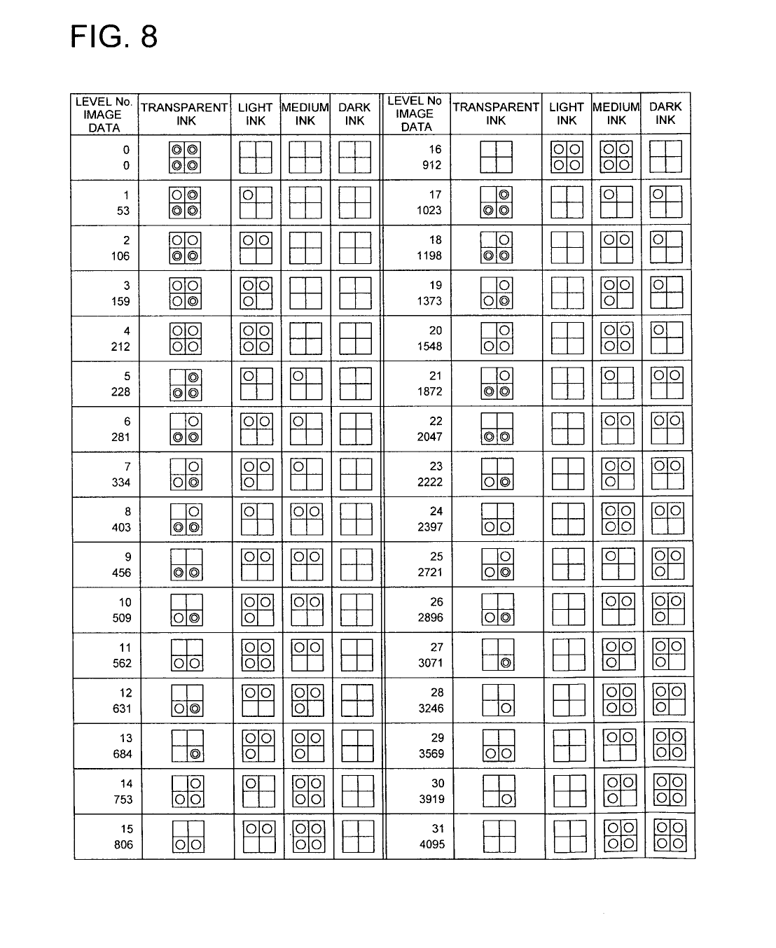

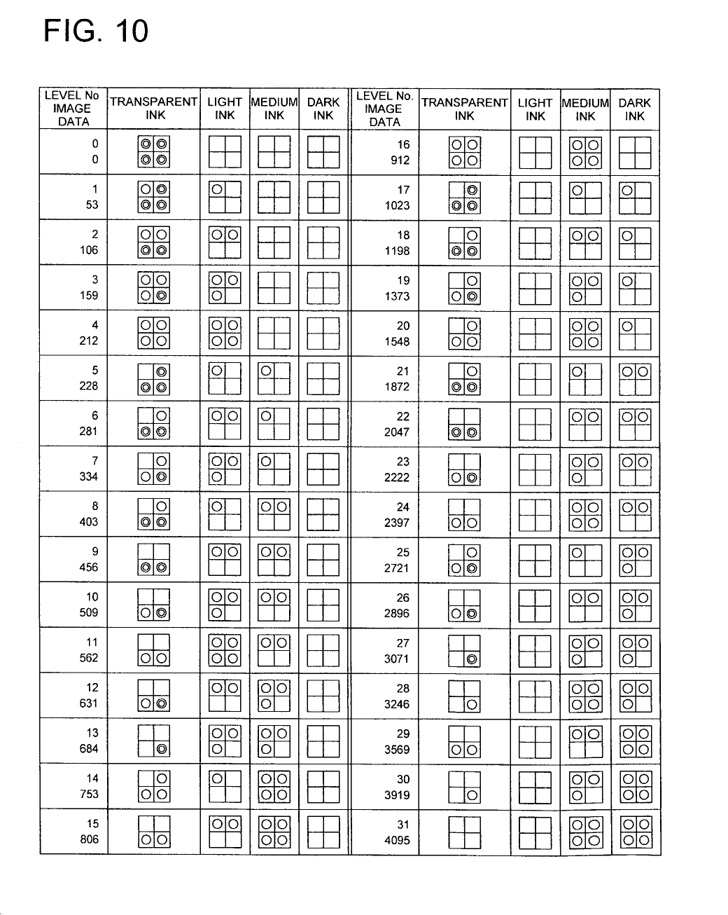

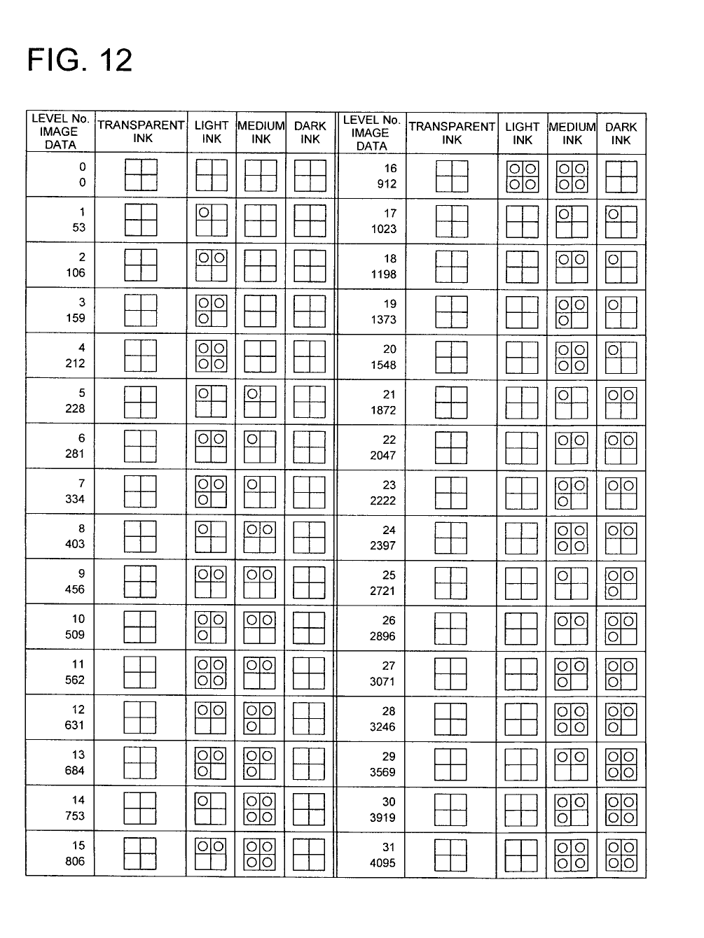

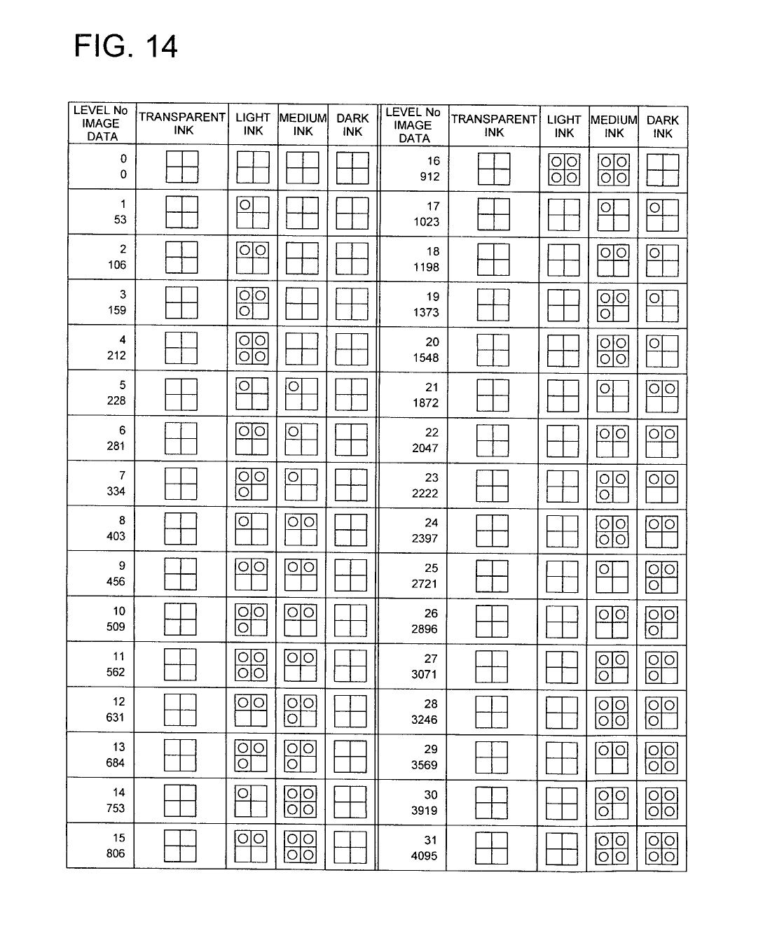

In this case, in Example 1-Example 4 and in Comparative Example 1 and Comparative Example 2, image densities corresponding to gradation levels of 32 steps from 0 to 31 are realized by forming dots of plural densities in 2×2 dot matrixes, as shown in FIG. 4, FIG. 6, FIG. 8, FIG. 10, FIG. 12 and FIG. 14. Incidentally, the number of the gradation level is not necessarily in proportion to image density.

TABLE 2
Relationship between ink and dot patterns used in Examples
and Comparative Examples

| | Dot | | Very | | | |
|---|---|---|---|---|---|---|
| | pattern | Transparent | light | Light | Medium | Dark |
| | diagram | ink | ink | ink | ink | ink |
| Example 1 | | Not used | 1-2 | 1-3 | 1-4 | 1-5 |
| Example 2 | | 1-1 | 1-2 | 1-3 | 1-4 | 1-5 |
| Example 3 | | 2-1 | Not | 2-3 | 2-4 | 2-5 |
| | | | used | | | |
| Example 4 | | 3-1 | Not | 3-3 | 3-4 | 3-5 |
| | | | used | | | |
| Comparative | | Not used | Not | 2-3 | 2-4 | 2-5 |
| Example 1 | | | used | | | |
| Comparative | | Not used | Not | 3-3 | 3-4 | 3-5 |
| Example 2 | | | used | | | |

### EXAMPLE 1

Ink with four types of densities included in ink set 1 are used, and control is conducted so that the content of organic solvent may be constant without depending on dye density of the ink and an amount of sticking ink may be constant in gradation levels 8-25.

To be concrete, ink having each density and its jet pattern (dot pattern) are those shown in FIG. 4. In FIG. 4, “◯” shows that one droplet is jetted on the same place and “502 ” shows that two droplets are jetted on the same place. Since an amount of sticking ink is made to be constant in the gradation levels 8-25, eight droplets in total are jetted in the control.

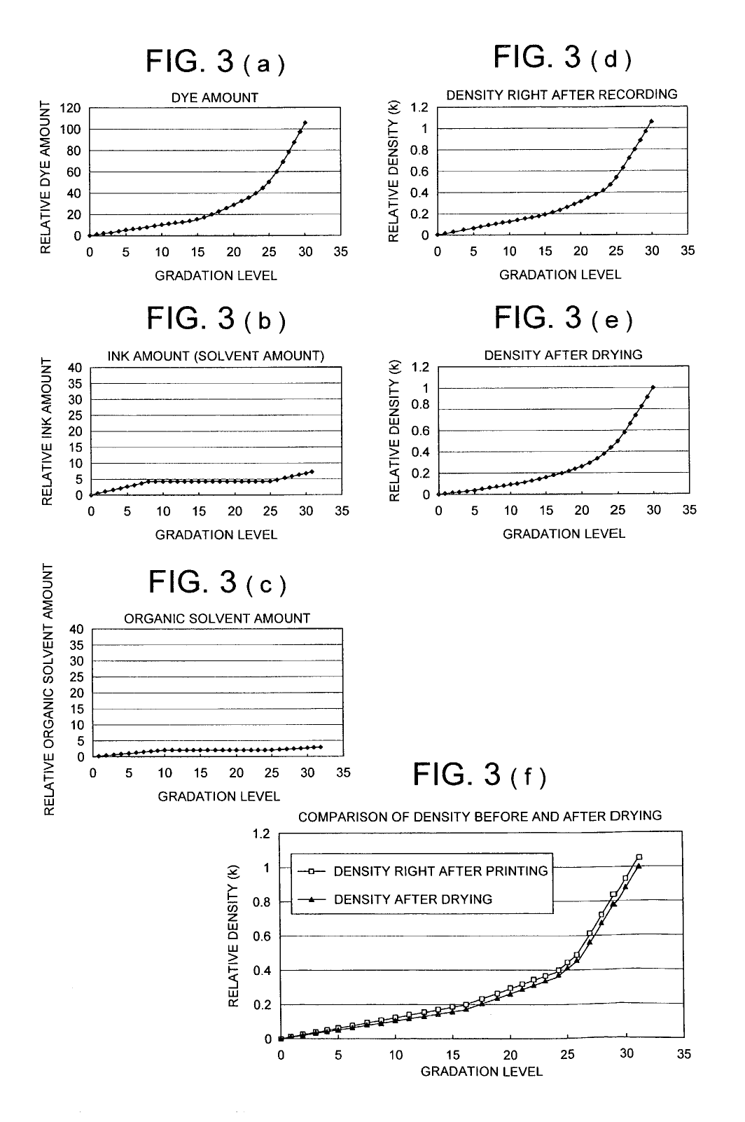

The foregoing makes an amount of solvents and an amount of sticking organic solvents to be constant in gradation levels 8-25 (refer to FIG. 3(b) and FIG. 3(c)). In this case, the control to make an amount of sticking ink to be constant in the gradation levels 8-25 corresponds to K1=0.088 and k2=0.485 of the above-mentioned expression, and it is the control in the density range in which the great importance is attached to the gradation in image diagnosis. Incidentally, in the area where no control to make an amount of sticking ink to be constant is conducted, there is conducted the control to increase an amount of sticking ink simply.

As a result, the relationship between the gradation level right after recording and density is like that shown in FIG. 3 (d). Further, the relationship between the gradation level after drying and density is like that shown in FIG. 3(e). A comparison between the density right after recording and the density after drying shows a parallel movement in the gradation level where an amount of sticking ink is made to be constant and shows a change of simple increase of the density corresponding to simple increase of an amount of sticking ink on other areas, as shown in FIG. 3(f).

The axis of ordinates in each of FIGS. 3(d)-3(f) represents a relative density, and when the recordable minimum density is represented by Dmin (corresponding to gradation level 0 in this case) and when the recordable maximum density is represented by Dmax (corresponding to gradation level 31 in this case), Dmin after drying is made to be 0 and (Dmax−Dmin) after drying is made to be 1. Namely, it corresponds to k for which the density after drying is expressed as Dmin+k (Dmax−Dmin). Therefore, a value of the axis of ordinates that corresponds to level 8 of the axis of abscissas corresponds to k1 (=0.088), and a value of the axis of ordinates that corresponds to level 8 of the axis of abscissas corresponds to k1 (=0.088), and a value of the axis of ordinates that corresponds to level 25 of the axis of abscissas corresponds to k2 (=0.485). This also applies to each of FIGS. 3(d)-3(f), FIGS. 5(d)-5(f), FIGS. 7(d)-7(f), FIGS. 9(d)-9(f), FIGS. 11(d)-11(f) and FIGS. 13(d)-13(f).

If an amount of sticking ink and an amount of sticking organic solvent are constant without depending on image density (gradation level), there becomes the situation wherein a density change caused by evaporation of water in a solvent and scattering of light caused by an organic solvent in a recording medium do not depend on image density (gradation level). Namely, only difference between the moment right after image recording and the moment after the lapse of a certain period of time in a prescribed gradation range (for example, a density range where great importance is attached to the gradation in image diagnosis) is only parallel movement of gradation characteristics, which brings the state of no feeling of physical disorder even if the gradation characteristics are changed, which is preferable. As a result, it becomes possible to prevent occurrence of a pseudo contour after drying and to obtain a medical image hard copy having excellent gradation and image quality.

### EXAMPLE 2

Ink set 1 including transparent ink and ink with four types of densities is used, and the control is conducted so that the content of organic solvent is constant without depending on dye density of the ink and an amount of sticking ink is made to be constant in gradation levels 0-31 (overall density areas).

To be concrete, ink having each density and its jet pattern (dot pattern) are those shown in FIG. 6. In FIG. 6, “◯” shows that one droplet is jetted on the same place and “⊚” shows that two droplets are jetted on the same place. Since an amount of sticking ink is made to be constant in the gradation levels 0-31, the control to jet 8 droplets in total is conducted.

When using a plurality of ink, two types of ink whose densities are adjoining each other are used.

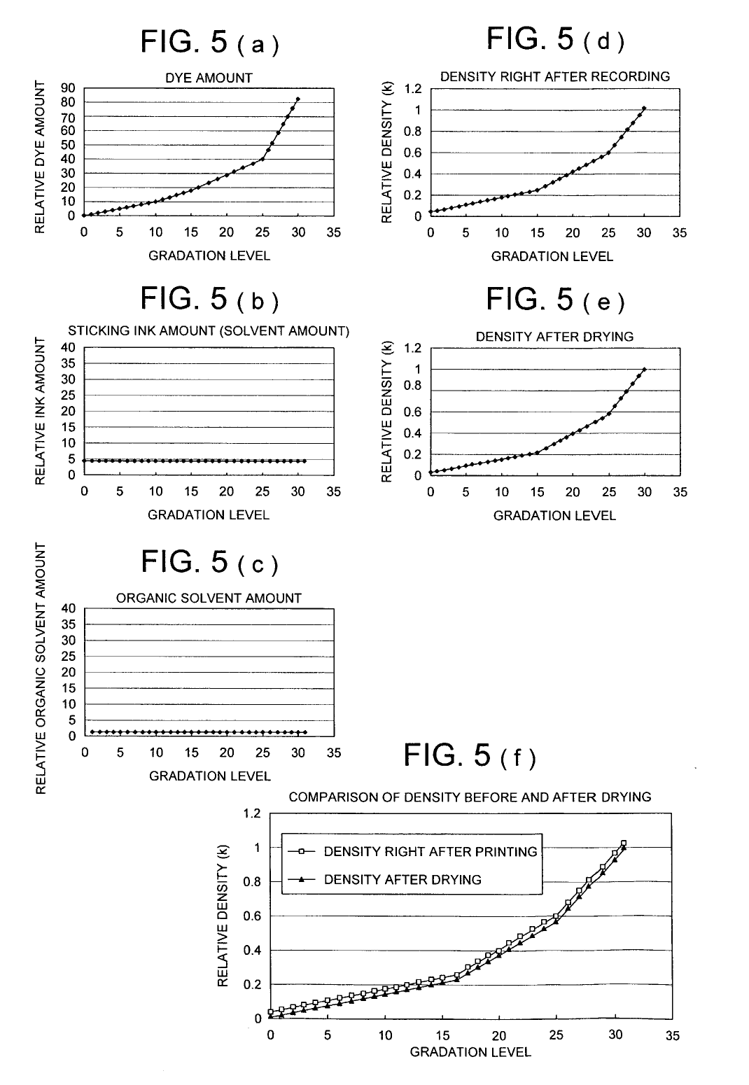

The foregoing makes an amount of solvent and an amount of sticking organic solvent to be constant in gradation levels 0-31 (refer to FIG. 5(b) and FIG. 5(c)). In this case, with regard to the control to make an amount of sticking ink to be constant in the gradation levels 0-31, it corresponds k1=0 and k2=1.0 in the expression described above to be the control on the total density areas including a density range where great importance is attached to the gradation property in image diagnosis.

As a result, the relationship between the gradation level right after recording and density is like that shown in FIG. 5(d). Further, the relationship between the gradation level after drying and density is like that shown in FIG. 5(e). A comparison between the density right after recording and the density after drying shows a parallel movement in the all gradation levels where an amount of sticking ink is made to be constant, as shown in FIG. 5(f).

If an amount of sticking ink and an amount of sticking organic solvent are constant without depending on image density (gradation level), there becomes the situation wherein a density change caused by evaporation of water in a solvent and scattering of light caused by an organic solvent in a recording medium do not depend on image density (gradation level). Namely, only difference between the moment right after image recording and the moment after the lapse of a certain period of time in a range of total gradations is only parallel movement of gradation characteristics, which brings the state of no feeling of physical disorder even if the gradation characteristics are changed, which is preferable. As a result, it becomes possible to prevent occurrence of a pseudo contour after drying and to obtain a medical image hard copy having excellent gradation and image quality.

### EXAMPLE 3

Ink set 2 including transparent ink and ink with three types of densities is used, and the control is conducted so that the content of organic solvent is constant without depending on dye density of the ink and an amount of sticking ink is made to be constant in gradation levels 0-31 (overall density areas).

To be concrete, ink having each density and its jet pattern (dot pattern) are those shown in FIG. 8. In FIG. 8, “◯” shows that one droplet is jetted on the same place and “⊚” shows that two droplets are jetted on the same place. Since an amount of sticking ink is made to be constant in the gradation levels 0-31, the control to jet 8 droplets in total is conducted.

In the control, transparent ink is used on all gradation levels, and in the case of ink other than the transparent ink, it is used in a way that the number of droplets of the ink with the same density is one for the same place. Therefore, three types of ink including transparent ink are used when occasion demands.

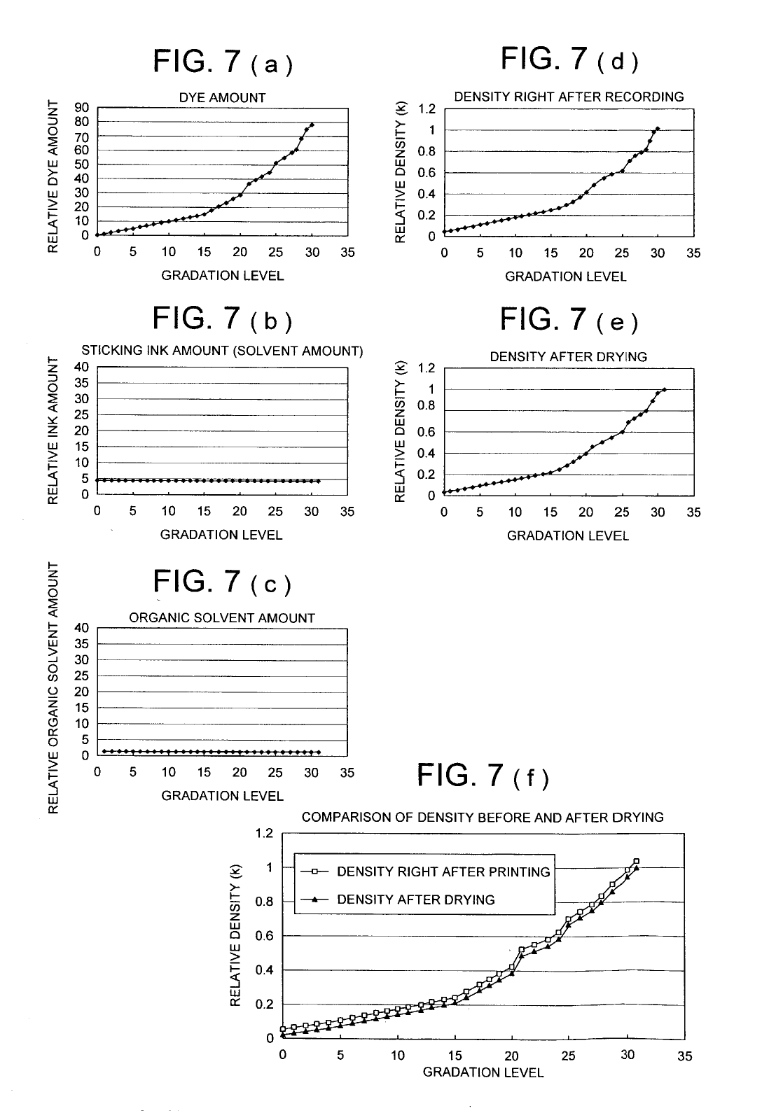

The foregoing makes an amount of solvent and an amount of sticking organic solvent to be constant in gradation levels 0-31 (refer to FIG. 7(b) and FIG. 7(c)). In this case, with regard to the control to make an amount of sticking ink to be constant in the gradation levels 0-31, it corresponds k1=0 and k2=1.0 in the expression described above to be the control on the total density areas including a density range where great importance is attached to the gradation property in image diagnosis.

As a result, the relationship between the gradation level right after recording and density is like that shown in FIG. 7(d). Further, the relationship between the gradation level after drying and density is like that shown in FIG. 7(e) . A comparison between the density right after recording and the density after drying shows a parallel movement in the all gradation levels where an amount of sticking ink is made to be constant, as shown in FIG. 7(f).

If an amount of sticking ink and an amount of sticking organic solvent are constant without depending on image density (gradation level), there becomes the situation wherein a density change caused by evaporation of water in a solvent and scattering of light caused by an organic solvent in a recording medium do not depend on image density (gradation level). Namely, only difference between the moment right after image recording and the moment after the lapse of a certain period of time in a range of total gradations is only parallel movement of gradation characteristics, which brings the state of no feeling of physical disorder even if the gradation characteristics are changed, which is preferable. As a result, it becomes possible to prevent occurrence of a pseudo contour after drying and to obtain a medical image hard copy having excellent gradation and image quality.

### EXAMPLE 4

Ink set 3 including transparent ink and ink with three types of densities is used, and the control is conducted so that the content of organic solvent is constant without depending on dye density of the ink and an amount of sticking ink is made to be constant in gradation levels 0-31 (overall density areas).

To be concrete, ink having each density and its jet pattern (dot pattern) are those shown in FIG. 10. In FIG. 10, “◯” shows that one droplet is jetted on the same place and “⊚” shows that two droplets are jetted on the same place. Since an amount of sticking ink is made to be constant in the gradation levels 0-31, the control to jet 8 droplets in total is conducted.

In the control, transparent ink is used on all gradation levels, and in the case of ink other than the transparent ink, it is used in a way that the number of droplets of the ink with the same density is one for the same place. Therefore, three types of ink including transparent ink are used when occasion demands.

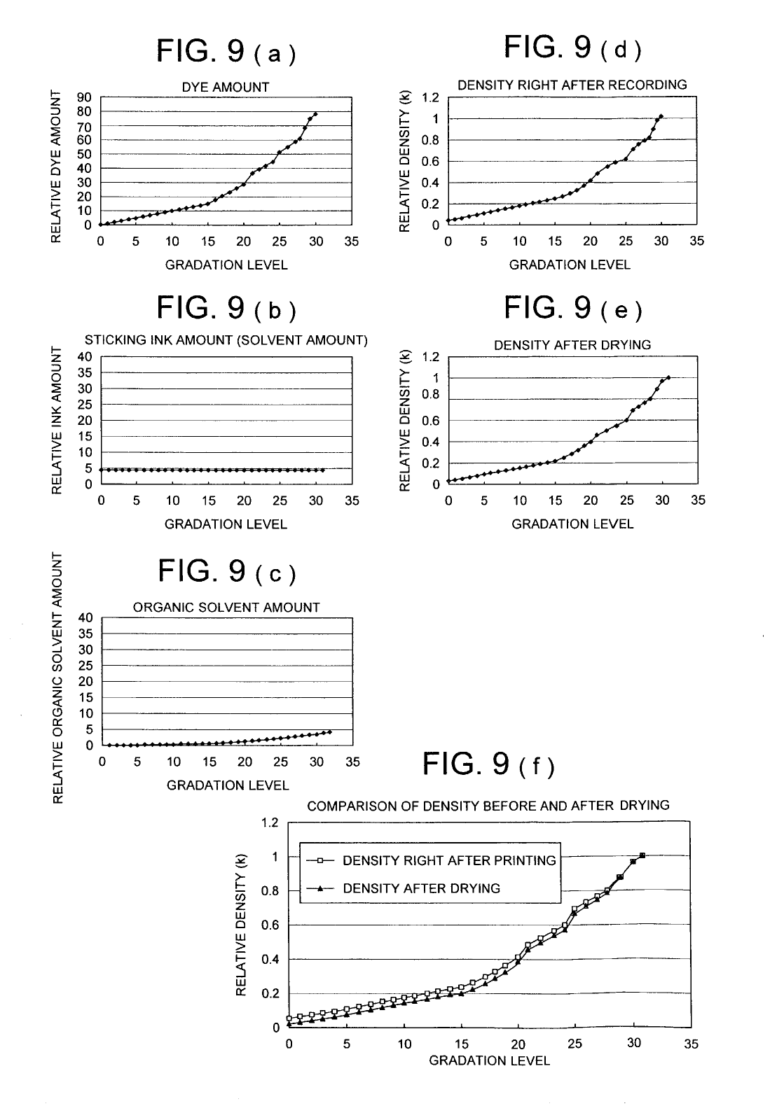

Though the foregoing makes an amount of solvent to be constant in gradation levels 0-31 (refer to FIG. 9(b)), an amount of sticking organic solvent is made to be almost proportional to the gradation level (refer to FIG. 9(c)). In this case, with regard to the control to make an amount of sticking ink to be constant in the gradation levels 0-31, it corresponds k1=0 and k2=1.0 in the expression described above to be the control on the total density areas including a density range where great importance is attached to the gradation property in image diagnosis.

As a result, the relationship between the gradation level right after recording and density is like that shown in FIG. 9(d). Further, the relationship between the gradation level after drying and density is like that shown in FIG. 9(e). A comparison between the density right after recording and the density after drying shows a parallel movement in the all gradation levels where an amount of sticking ink is made to be constant, as shown in FIG. 9(f).

If an amount of sticking ink is constant without depending on image density (gradation level), and an amount of sticking organic solvent is mostly proportional to image density (gradation level), there becomes the situation wherein density stays on a simple increase and no reversing of density takes place although a curve of gradation characteristics is changed, and there is made no big change in how to look, which is preferable. As a result, it becomes possible to prevent occurrence of a pseudo contour and aging change of image gradation characteristics and to obtain a medical image hard copy having excellent gradation and image quality.

### Comparative Example 1

Ink having three types of densities included in ink set 2 are used, and a content of organic solvent is constant without depending on density of dye in ink, but, there is conducted no control to make an amount of sticking ink to be constant in gradation levels 0-31.

To be concrete, ink having each density and its jet pattern (dot pattern) are those shown in FIG. 12. In FIG. 12, “◯” shows that one droplet is jetted on the same place, representing a conventional and general dot pattern wherein no control about the number of droplets is conducted.

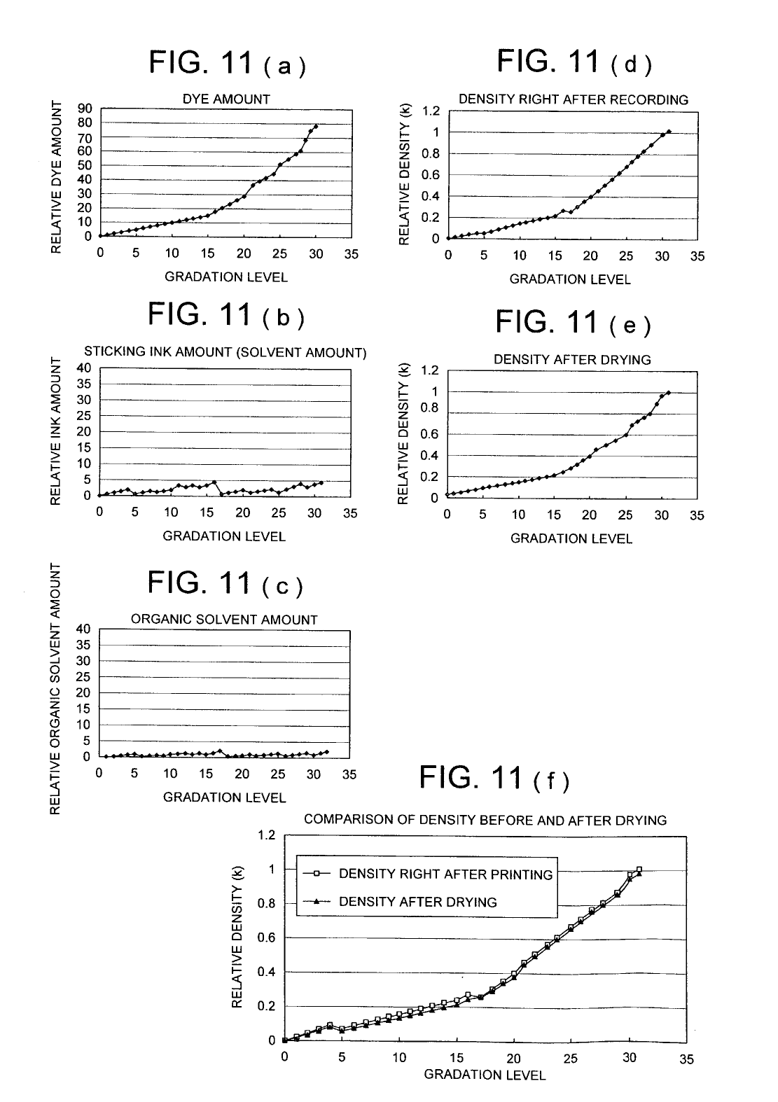

Being caused by the foregoing, an amount of solvent and an amount of organic solvent are changed in gradation levels 0-31, and there becomes the state where increase and decrease are repeated for several times (refer to FIG. 11(b) and FIG. 11(c)).

As a result, relationship between the gradation level right after recording and the density is like that shown in FIG. 11(d), and reversing of density takes place in the vicinity of level 4-level 5 and in the vicinity of level 16-level 17, depending on a difference of an amount of solvent.

Further, relationship between the gradation level after drying of ink and the density is like that shown in FIG. 11(e). In this FIG. 11(e), when it is compared with FIG. 11(d), the reversing of density still remains although the degrees of density reversing in the vicinity of level 4-level 5 and in the vicinity of level 16-level 17 are slightly lower. When comparing density right after recording with that after drying, a change of density is not constant, and a form of characteristics is changed, as shown in FIG. 11(f).

Namely, an amount of ink, that is an amount of solvent occupying the most part of the ink varies depending on the gradation level. Since an amount of raising of transmission density caused by a solvent sticking to the inside of a void varies depending on the gradation level, the image density does not increase simply for the amount of sticking dye, and a phenomenon of reversing sometimes takes place. When an amount of raising of density is decreased by evaporation of water in the sticking solvent, the degree of aging change also varies depending on the gradation level, because the density raised by solvent varies depending on the gradation level, the image looks as if it were subjected to different processing before and after drying. Further, when the percentage of content of organic solvent is constant without depending on the dye density of ink, an amount of organic solvent is almost proportional to an amount of sticking ink. Therefore, raising of density caused by organic solvent varies depending on the gradation level, and a pseudo contour is not solved completely even after sufficient drying of moisture.

### Comparative Example 2

Ink having three types of densities included in ink set 3 are used, and a content of organic solvent is almost proportional to dye density of ink accordingly. There is conducted no control to make an amount of sticking ink to be constant in gradation levels 0-31.

To be concrete, ink having each density and its jet pattern (dot pattern) are those shown in FIG. 14. In FIG. 14, “◯” shows that one droplet is jetted on the same place, representing a conventional and general dot pattern wherein no control about the number of droplets is conducted.

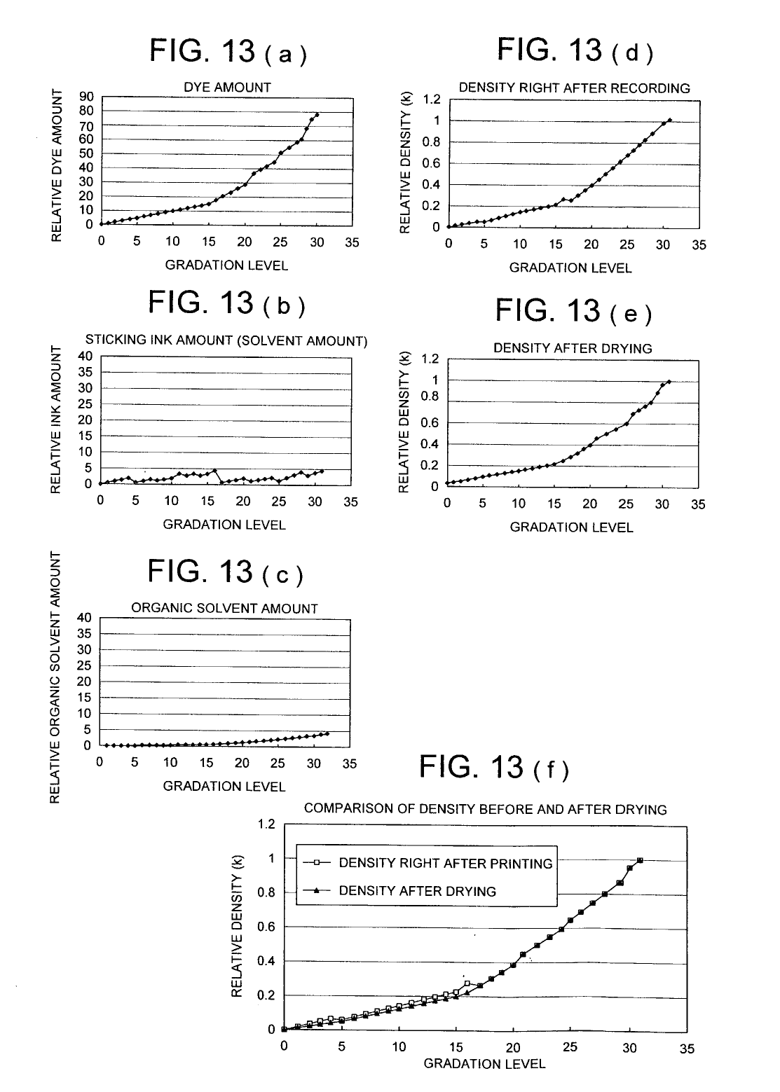

Being caused by the foregoing, an amount of solvent is changed in gradation levels 0-31, and there becomes the state where increase and decrease are repeated for several times (refer to FIG. 13(b)), but, an amount of sticking organic solvent is mostly proportional to the gradation level (refer to FIG. 13(c)).

As a result, relationship between the gradation level right after recording and the density is like that shown in FIG. 13(d), and reversing of density takes place in the vicinity of level 4-level 5 and in the vicinity of level 16 -level 17, depending on a difference of an amount of solvent. Further, relationship between the gradation level after drying of ink and the density is like that shown in FIG. 13(e). In this FIG. 13(e), there becomes the state where density reversing is solved by drying of moisture in ink. When density right after recording is compared with density after drying, density reversing is caused first, and it is solved later as shown in FIG. 13(f). Therefore, a change of density is not constant, and a form of characteristics is changed, as shown in FIG. 11(f).

Namely, since the raising of density caused by organic solvent included to be almost in proportion to dye density increases simply for the gradation level, a pseudo contour caused by density reversing does not take place after drying. However, a pseudo contour right after printing and aging change of gradation property are generated, because raising of density right after printing varies depending on an amount of sticking solvent (an amount of ink).

Further, since the evaporation speed of moisture varies depending on density of an organic solvent, the time required to reach the stable condition varies depending on the gradation level, resulting in changing of impression to look at on the half way of drying.

### Comparison between Example and Comparative Example

Chest front images obtained through reading by the CR (Computed Radiography) system made by Konica Corporation, by the use of Examples 1-4 and Comparative Examples 1 and 2 stated above were printed and were observed on the viewing lantern for visual evaluation. The results of the evaluations are shown in Table 3 in which the results of the evaluation is ranked to be “very good”, “good”, “not good but passable” and “very bad”.

Incidentally, image data used are in 12 bits and have 4096 gradations to be capable of taking 0-4095 signal values. In FIG. 4 corresponding to Example 1, a value of image data corresponding to the gradation level number is indicated under that gradation level number. Namely, in the Example 1, it is shown that the image density is formed by dot patterns corresponding to gradation level 0 when the value of image-data is in a range of 0-44, while the image density is formed by dot patterns corresponding to gradation level 1 when the value of image data is in a range of 45-89. In the same way as in the foregoing, the image data and gradation level (dot pattern) correspond each other, and the dot pattern of the highest density corresponding to gradation level 31 is recorded only when the value of image data is 4095, in the structure. This applies also to other examples.

TABLE 3
Results of image evaluation

| | | | Difference of |
|---|---|---|---|
| | Gradation | | gradation |
| | characteristics | Gradation | between |
| | right after | characteristics | before and |
| | printing | after drying | after drying |
| Example 1 | good | good | good |
| Example 2 | very good | very good | very good |
| Example 3 | very good | very good | very good |
| Example 4 | very good | good | passable |
| Comparative | | | |
| Example 1 | very bad | very bad | very bad |
| Comparative | | | |
| Example 2 | very bad | good | very bad |

As shown in Table 3, gradation characteristics right after printing proved to be very good in Examples 2, 3 and 4, good in Example 1, and very bad in Comparative Examples 1 and 2. Further, gradation characteristics after drying proved to be very good in Examples 2 and 3, good in Examples 1 and 4 and Comparative Examples 2, and very bad in Comparative Examples 1. Difference of gradation between before and after drying proved to be very good in Examples 2 and 3, good in Example 1, bad in Example 4 and very bad in Comparative Examples 1 and 2.

In the overall results of the foregoing, Examples 1, 2 and 3 have no bad point, and they can be evaluated to be extremely excellent. Example 4 showed good results in all evaluation items except the item of difference of gradation between before and after drying which was not as good as other Examples, resulting in good overall evaluation.

Further, under the condition that the number of dots is constant without depending on image density (gradation level), and the number of densities of ink used simultaneously is made to be one, or two adjoining in the order of coloring material density (two kinds in Example 2), there becomes the state wherein raising of density caused by a solvent in an ink receiving layer right after image recording does not depend on image density (gradation level), and local density unevenness in a dot matrix can be controlled to be minimum. As a result, it becomes possible to prevent occurrence of a pseudo contour and to obtain not only a high quality medical image hard copy having excellent gradation but also a medical image hard copy excellent in graininess. In this case, in Example 2, the difference of gradation between before and after drying was smallest, and extremely excellent results were obtained.

Incidentally, with respect to the control to make an amount of sticking ink and an amount of sticking organic solvent to be constant, it was confirmed by separate experiments that sufficient effect can be obtained by controlling to be within a range of error 10%. Since an error of about 10% is allowed as stated above, it is possible to prevent occurrence of pseudo contour and an aging change of image gradation characteristics, and to obtain stably a medical image hard copy that is excellent in both gradation and image quality.

Comparative Examples 1 and 2 were evaluated to be very bad in terms of gradation change right after recording and gradation change before and after drying, and they were confirmed not to be suitable for obtaining a medical image hard copy that is excellent in both gradation and image quality.

### Other Embodiments

In the embodiment stated above, explanation was made for the occasion to indicate density gradation on a recording medium by forming a plurality of ink dots in a 2×2 dot matrix. However, the invention can be applied to various methods for forming halftone images without being limited to the foregoing.

For example, the matrix can be changed to 3×3 or 4×4, or, pseudo halftone may be indicated by an error diffusion method. It is further possible to use a dot matrix method and an error diffusion method in combination.

For example, in FIG. 4 of the invention, with respect to image density whose image data correspond to 1-44, it is also possible to use a dot matrix corresponding to gradation level 0 and a dot matrix corresponding to gradation level 1 and thereby to indicate a halftone by an error diffusion method. In the same way, a halftone between gradation levels can be indicated by an error diffusion method.

Incidentally, excellent results were also obtained by the following values in addition to the concrete values shown in the aforesaid examples. Namely, it was possible to prevent occurrence of pseudo contour and aging change of image gradation characteristics, and to obtain a medical image hard copy having both excellent gradation characteristics and high image quality, by controlling so that an amount of ink or an amount of organic solvent sticking to a recording medium, or an amount of sticking ink and an amount of sticking organic solvent may be mostly constant even when density to be recorded is different, in the case of solid recording within a density range from Dmin+k1×(Dmax−Dmin) to Dmin+k2×(Dmax−Dmin) concerning at least one of combinations of values k1, k2, when there hold 0≦k1<1, 0<k2<≦1.0, and k1<k2. Further, it was also possible to prevent occurrence of a pseudo contour and aging change of image gradation characteristics and to obtain a medical image hard copy having both excellent gradation characteristics and image quality in the same way, by making k1 and k2 to be respectively 0.15 and 0.4. It was further possible to prevent occurrence of pseudo contour and aging change of image gradation characteristics, and to obtain a medical image hard copy having both excellent gradation characteristics and high image quality, by making k1 and k2 to be respectively 0.1 and 0.6.

As explained in detail above, the present invention makes it possible to prevent occurrence of a pseudo contour and aging change of image gradation characteristics and to obtain a medical image hard copy having both excellent gradation characteristics and high image quality.

Disclosed embodiment can be varied by a skilled person without departing from the spirit and scope of the invention.

What is claimed is:

1. An apparatus for recording an image on a recording medium, comprising:
an ink-jetting head to emit ink particles onto said recording medium; and
a controlling section to control said ink-jetting head, so that a total amount of said ink particles per unit area, emitted by said ink-jetting head and adhered onto said recording medium, is maintained at substantially a constant value even if density of a solid-tone image area, to be recorded on said recording medium, varies within density range D;
wherein, with respect to at least one of combinations of values k1, k2 selected under conditions of
0≦k1<1, 0<k2≦1.0, and k1<k2,
said density range D fulfils the following equation,
Dmin+k1(Dmax−Dmin)≦D≦Dmin+k2 (Dmax−Dmin)
where,
Dmax: a recordable maximum-density,
Dmin: a recordable minimum-density.

2. The apparatus of claim 1,
wherein said ink particles includes at least one of more than three kinds of inks having densities different each other in a same color tone.

3. The apparatus of claim 2,
wherein said image is a medical image and said apparatus is an ink-jetting recording apparatus for medical use.

4. The apparatus of claim 1,
wherein said ink particles includes an organic solvent; and
wherein said controlling section controls said ink-jetting head, so that a total amount of said organic solvent per unit area is also maintained at substantially a constant value even if density of said solid-tone image area, to be recorded on said recording medium, varies within said density range D.

5. The apparatus of claim 3,
wherein gradation of said image is created on said recording medium by forming dots in a dot-matrix including a plurality of cells, based on image data inputted into said apparatus, and said ink-jetting head emits said ink particles onto said recording medium so as to form said dots; and
wherein said controlling section controls said ink-jetting head, so that an ink amount per each of said dots is kept at substantially a constant value and a total number of said dots in said dot-matrix, formed by said ink-jetting head onto said recording medium, is maintained at substantially a constant value even if density of said solid-tone image area, to be recorded on said recording medium, varies within said density range D.

6. The apparatus of claim 5,
wherein a weight ratio of an organic solvent included in said ink particles is constant, irrespective of a density of a color material employed.

7. The apparatus of claim 3,
wherein said ink particles have either a uniform density or two kinds of densities adjacent each other in order of color-material densities.

8. The apparatus of claim 3,
wherein said values k1, k2 are defined as
k1=0.15, k2=0.4.

9. The apparatus of claim 3,
wherein said values k1, k2 are defined as
k1=0.1, k2=0.6.

10. The apparatus of claim 3,
wherein said values k1, k2 are defined as
k1=0, k2=1.0.

11. The apparatus of claim 2,
wherein a transparent ink is included in said more than three kinds of inks.

12. The apparatus of claim 3,
wherein said recording medium is transparent.

13. The apparatus of claim 3,
wherein said total amount of said ink particles per unit area is controlled at substantially said constant value within a controlling error range of 10%.

14. The apparatus of claim 3,
wherein, with respect to density range A other than said density range D, said controlling section controls said ink-jetting head, so that said total amount of said ink particles per unit area increases monotonically with increasing density in said density range A.

15. An apparatus for recording an image on a recording medium, comprising:
an ink-jetting head to emit ink particles onto said recording medium; and
a controlling section to control said ink-jetting head, so that a total amount of organic solvent per unit area, included in said ink particles emitted by said ink-jetting head and adhered onto said recording medium, is maintained at substantially a constant value even if density of a solid-tone image area, to be recorded on said recording medium, varies within density range D;
wherein, with respect to at least one of combinations of values k1, k2 selected under conditions of
0≦k1<1, 0<k2≦1.0, and k1<k2,
said density range D fulfils the following equation,
Dmin+k1(Dmax−Dmin)≦D≦Dmin+k2 (Dmax−Dmin)
where,
Dmax: a recordable maximum-density,
Dmin: a recordable minimum-density.

16. The apparatus of claim 15,
wherein said ink particles includes at least one of more than three kinds of inks having densities different each other in a same color tone.

17. The apparatus of claim 16,
wherein said image is a medical image and said apparatus is an ink-jetting recording apparatus for medical use.

18. The apparatus of claim 17,
wherein gradation of said image is created on said recording medium by forming dots in a dot-matrix including a plurality of cells, based on image data inputted into said apparatus, and said ink-jetting head emits said ink particles onto said recording medium so as to form said dots; and
wherein said controlling section controls said ink-jetting head, so that an ink amount per each of said dots is kept at substantially a constant value and a total number of said dots in said dot-matrix, formed by said ink-jetting head onto said recording medium, is maintained at substantially a constant value even if density of said solid-tone image area, to be recorded on said recording medium, varies within said density range D.

19. The apparatus of claim 17,
wherein said ink particles have either a uniform density or two kinds of densities adjacent each other in order of color-material densities.

20. The apparatus of claim 17,
wherein said values k1, k2 are defined as
k1=0.15, k2=0.4.

21. The apparatus of claim 17,
wherein said values k1, k2 are defined as
k1=0.1, k2=0.6.

22. The apparatus of claim 17,
wherein said values k1, k2 are defined as
k1=0, k2=1.0.

23. The apparatus of claim 16,
wherein a transparent ink is included in said more than three kinds of inks.

24. The apparatus of claims 17,
wherein said recording medium is transparent.

25. The apparatus of claim 17,
wherein said total amount of said organic solvent per unit area is controlled at substantially said constant value within a controlling error range of 10%.

26. The apparatus of claim 17,
wherein, with respect to density range A other than said density range D, said controlling section controls said ink-jetting head, so that said total amount of said organic solvent per unit area increases monotonically with increasing density in said density range A.
